(19) United States
(12) Patent Application Publication
(10) Pub. No.: US 2006/0256953 A1
(43) Pub. Date: Nov. 16, 2006

(54) Method and system for improving workforce performance in a contact center

(75) Inventors: Kirt William Pulaski, Suwanee, GA (US); Matthew G. A. McConnell, Alpharetta, GA (US)

Correspondence Address: Michael L. Wach;Patent Agent, KING & SPALDING LLP, 191 Peachtree Street, N.E., 45th Floor, Atlanta, GA, 30303, US

(73) Assignee: Knowlagent, Inc., Alpharetta, GA (US)

(21) Appl. No.: 11/127,411

(22) Filed: May 12, 2005

(51) Int. Cl. H04M 3/00

(52) U.S. Cl. 379/265.06

(57) ABSTRACT

An agent in a contact center, such as a call center, can use a computer terminal while servicing a contact, such as an inbound caller. A software program can receive data about a step or action that the agent has taken in connection with servicing the contact. The software program can process the received data and can determine whether the action indicates that the agent or another member of the contact center's workforce would benefit from receiving training or coaching. If the software program determines that the workforce member would benefit from training, the software program can assign training, initiate a training session, or send training content to that workforce member.

### TECHNICAL FIELD

The present invention relates generally to contact centers, such as call service centers and more specifically to initiating a training or coaching session at a contact center based upon information obtained from monitoring interactions between the agent and a software program that the agent uses in connection with servicing contacts.

### BACKGROUND OF THE INVENTION

A contact center, such as a call center, is a system that enables a staff of agents to service telephone calls to or from customers or other constituents. Modern contact centers generally incorporate computer-based systems for automatically routing calls and managing various operational aspects of the contact center. Contact center operations benefit from the recent availability of automated systems that provide training to agents via a computer terminal.

Agents in contact centers need to be well-trained in order to maximize their productivity and effectiveness. Agent training should be intensive and frequent in centers that handle complex interactions with constituents or that change call scripts or other interaction programs often. In many situations, the quality and effectiveness of agent training may significantly drive the performance of the contact center in terms of achieving its business objectives.

In conventional contact centers, agents may receive training through a variety of mechanisms. A supervisor at the contact center may simply walk over to individual agents for face-to-face interaction, place telephone calls to individual agents, or otherwise pass new information to the agents personally. New information may be distributed by email, by an instructor in a classroom setting, or via an intranet. Alternatively, the information may be broadcast over a public announcement system or may be displayed on large wall displays or “reader boards” at various locations of the contact center. New information may also be provided through a “chair drop” or “huddle” by which written information updates or paper training materials are handed to the agents for their consumption.

More recently, automated methods for agent training and information updating have emerged. Computer-based training (“CBT”) involves the distribution of training programs to agents' desktop computer workstations or to a workstation dedicated to training. CBT content may be distributed in a broadcast mode, with each agent receiving the same training at the same time. However, CBT may also be deployed by allowing individual agents to access desktop training on their own schedules and at their own paces through self-directed CBT. In self-directed CBT, each agent takes the initiative to enter a training session, and the pace and content of the training can reflect an individual's learning rate and base knowledge. While agents may enjoy the flexibility of self-directed CBT, they often schedule conventional CBT training sessions in the interest of convenience rather than at times when the content would be most effective. Further, an agent may not schedule a learning break for a time that the learning process would be most efficient from a time-utilization perspective.

One conventional approach to CBT involves recording an agent servicing a contact for evaluation purposes or to identify training deficits. An experienced agent or a supervisor reviews the recording in an offline mode, for example at the end of a week or a shift, and assigns training content or offers suggestions intended to improve the recorded agent's performance. The time delay associated with recording the live contact-agent session, reviewing the recorded session, assigning training based on the review, and delivering conventional CBT training can result in delivering the training long after the live session. For example, the agent may receive the CBT training hours, days, or weeks following the recorded session. With this time delay, errors that the agent made while processing the contact may not be fresh in the agent's mind during the training session. Thus, the agent may not be able to effectively correlate the training content to the behavior that the training content was assigned to correct. This approach can also suffer from sampling error, since typically only about two percent of live contact sessions or episodes are recorded.

Conventional CBT programs often have additional shortcomings related to identifying an inclusive or comprehensive list of members of the contact center workforce that should receive training. For example, an agent whose behavior does not comply with the best practices of the contact center may receive CBT training, while a supervisor that taught that noncompliant behavior to the agent does not receive training. In this situation, the supervisor may propagate the noncompliant behavior to other agents without realizing that the problem exists.

Oftentimes, conventional CBT programs train agents to adopt certain practices that may or may not produce the desired result of improving agent performance. That is, conventional training content is often selected based on an unproven assumption that the techniques conveyed to the agents will help those agents process contacts more effectively. In many circumstances, little or no evidence exists to support the assumed correlation between the practices taught and the desired result. The agents that perform unsatisfactorily may be taught one set of contact-processing practices, while the agents that achieve stellar performance use a different set of practices.

To address these representative deficiencies in the art, what is needed is a capability for timely or real-time identification of agent behavior that indicates a need for training. The capability should initiate a training session at a selected time that will provide a strong impact on agent behavior. Another need exists for a capability of identifying agent behavior that indicates a need for training of an agent's supervisor or another member of the contact center's workforce. Yet another need exists for identifying effective contact-processing techniques. Such capabilities would heighten performance and proficiency of the workforce in the contact center and enhance operational effectiveness.

### SUMMARY OF THE INVENTION

The present invention supports improving the performance, efficiency, or effectiveness of one or more members of the workforce of a contact center. In one aspect of the present invention, a computer-implemented method can assign and/or deliver training or coaching content to a member of the workforce or initiate a training session. The member of the workforce can be an agent that services contacts or a supervisor that manages one or more agents. When an agent takes an action in connection with servicing a contact, a software program can receive data regarding the action. For example, the software program can receive notification that the agent has performed a step such as logging a sale, moving between display screens or windows at a computer terminal, or modifying a data field. The software program can process the received data to determine information about the action. For example, the software program can apply rules or determine whether the action meets a criterion. Processing the received data can comprise determining whether the action indicates that the agent or another member of the workforce would benefit from training or coaching. If the software program determines that the action is indicative of a training need, the software program can initiate a training session, make a training assignment, or send training content to the agent and/or the other workforce member.

The discussion of improving workforce performance in a contact center presented in this summary is for illustrative purposes only. Various aspects of the present invention may be more clearly understood and appreciated from a review of the following detailed description of the disclosed embodiments and by reference to the drawings and claims.

### BRIEF DESCRIPTION OF THE DRAWINGS

FIG. 1 is a functional block diagram illustrating an exemplary system for managing a computer-based contact center in accordance with an embodiment of the present invention.

FIG. 2 is a functional block diagram illustrating an exemplary system for improving workforce performance in a contact center in accordance with an embodiment of the present invention.

FIG. 3 is a functional block diagram illustrating an exemplary configuration of a system for improving workforce performance in a contact center in accordance with an embodiment of the present invention.

FIG. 4 is a functional block diagram illustrating an exemplary agent terminal coupled to a system for improving workforce performance in accordance with an embodiment of the present invention.

FIGS. 5A, 5B, and 5C are configuration windows of an exemplary GUI for a contact center supervisor in accordance with an embodiment of the present invention.

FIGS. 6A-C are user windows of an exemplary GUI for a contact center supervisor in accordance with an embodiment of the present invention.

FIG. 7 is a monitoring window of an exemplary GUI for a contact center supervisor in accordance with an embodiment of the present invention.

FIG. 8 is an agent detail window of an exemplary GUI for a contact center supervisor in accordance with an embodiment of the present invention.

FIGS. 9A and 9B are a flowchart of an exemplary process for identifying significant events occurring while an agent services a contact in accordance with an embodiment of the present invention.

FIG. 10 is a flowchart of an exemplary process for processing significant events occurring while an agent services a contact in accordance with an embodiment of the present invention.

FIG. 11 is a flowchart of an exemplary process for notifying an agent's supervisor in response to occurrences of certain events in accordance with an embodiment of the present invention.

FIG. 12 is a flowchart of an exemplary process for initiating training in response to occurrences of certain events in accordance with an embodiment of the present invention.

FIG. 13 is a flowchart of an exemplary process for generating a report of certain events in accordance with an embodiment of the present invention.

FIGS. 14A, B, and C are exemplary reports that chart event occurrences in accordance with an embodiment of the present invention.

FIG. 15 is a flowchart of an exemplary process for correlating results to occurrences of certain events in accordance with an embodiment of the present invention.

Many aspects of the invention can be better understood with reference to the above drawings. The components in the drawings are not necessarily to scale, emphasis instead being placed upon clearly illustrating the principles of exemplary embodiments of the present invention. Moreover, in the drawings, reference numerals designate corresponding parts throughout the several views.

### DETAILED DESCRIPTION OF EXEMPLARY EMBODIMENTS

Exemplary embodiments of the present invention can identify instances or situations in a contact center that indicate a need for training and promptly initiate delivery of training content to selected individuals, such as an agent or an agent's supervisor. The selected individuals can receive the training content at a time when the content is likely to have a positive impact on the selected individual's performance. That selected time can immediately follow an agent-contact encounter that demonstrates a need for training, before an agent services another contact.

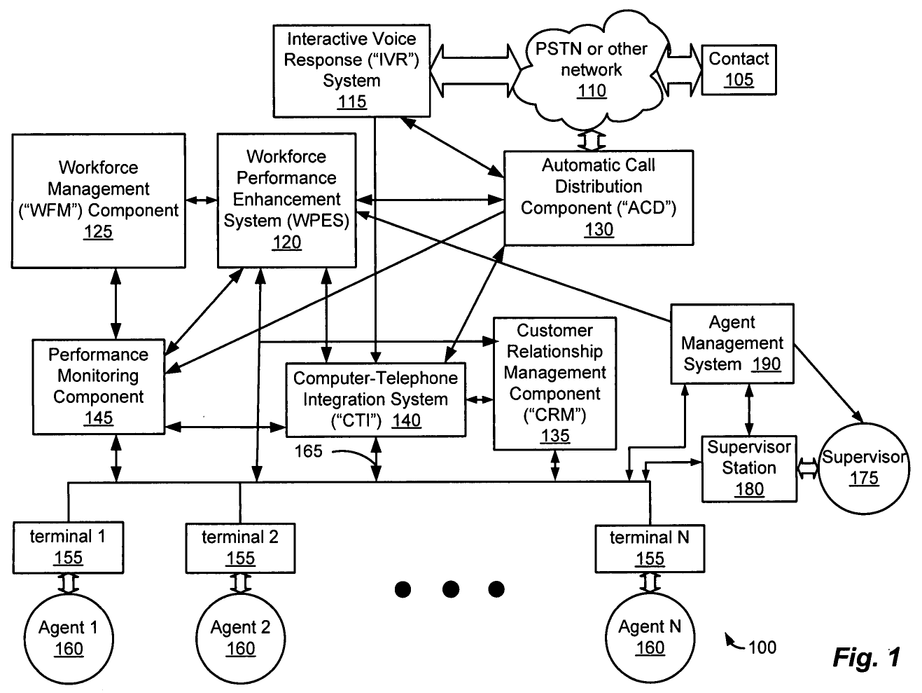

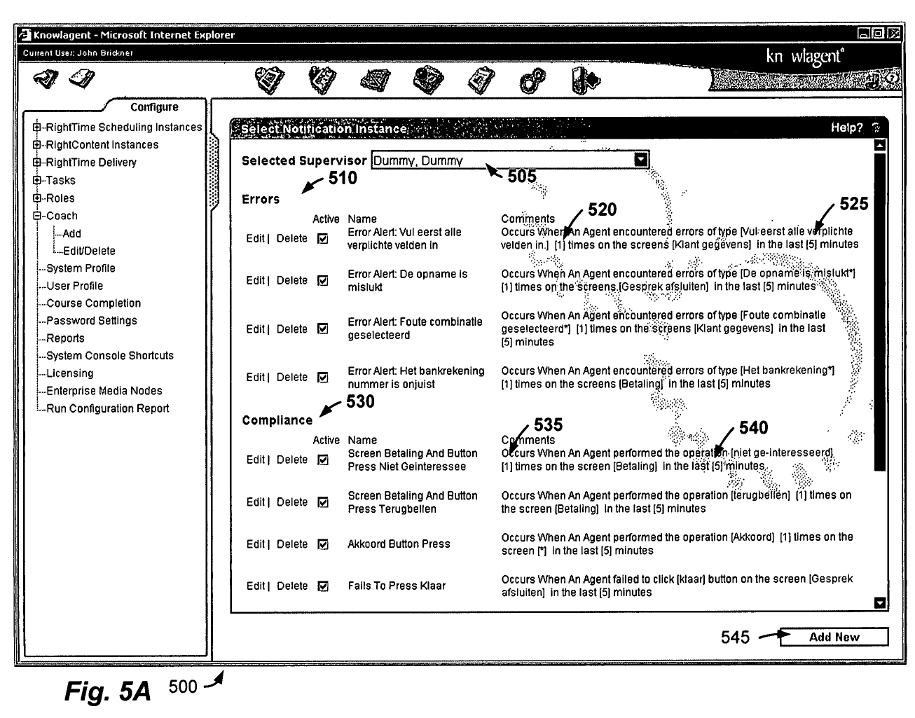

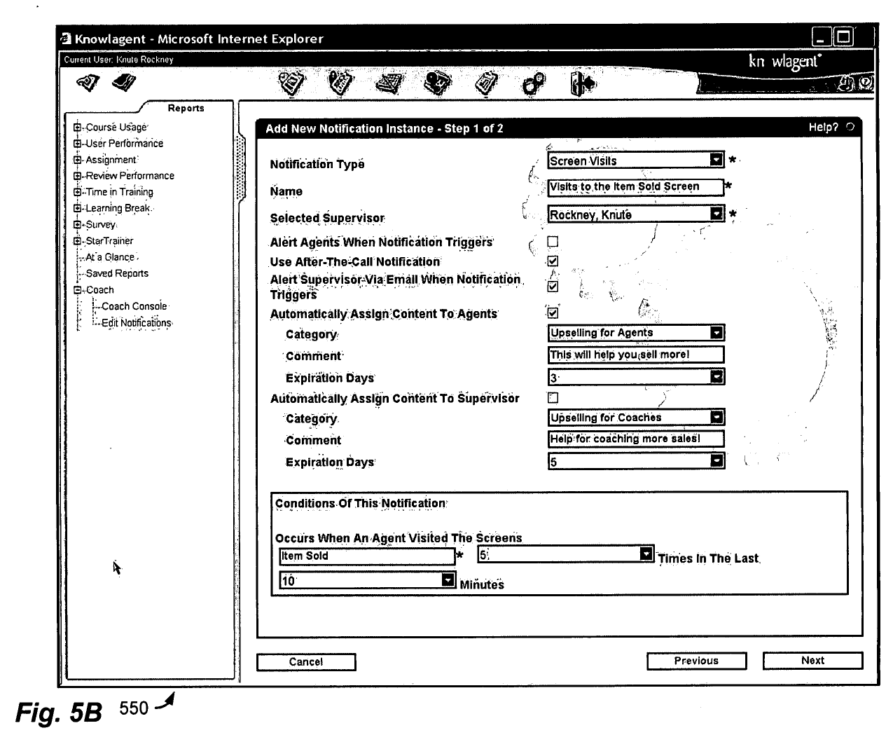

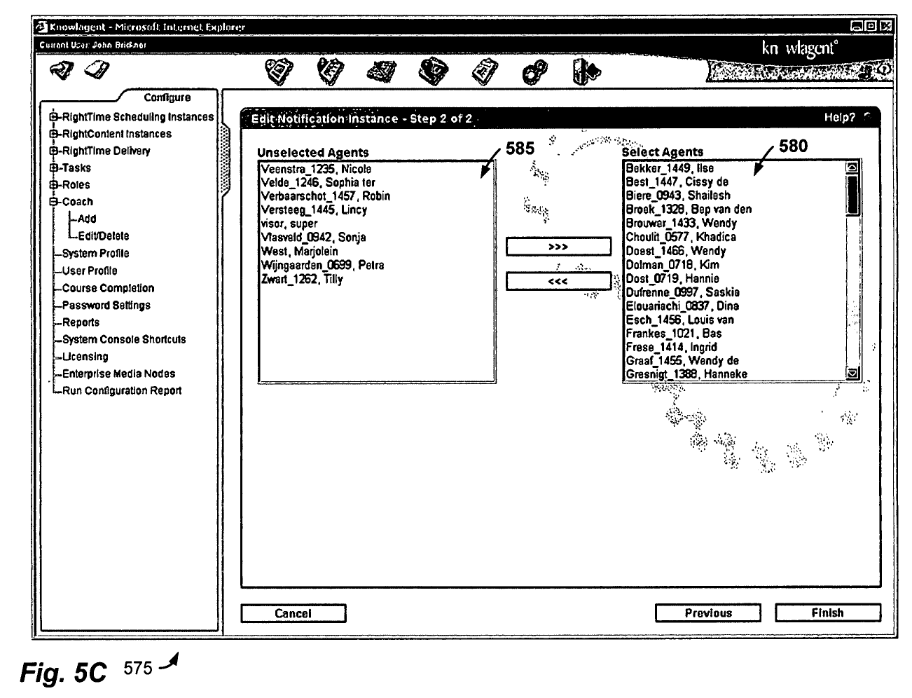

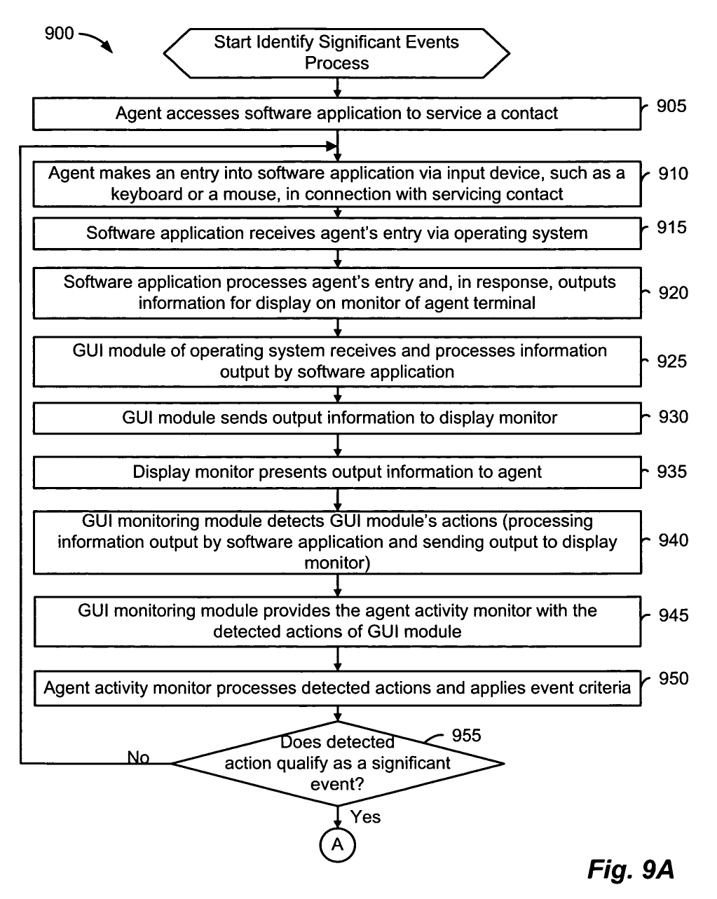

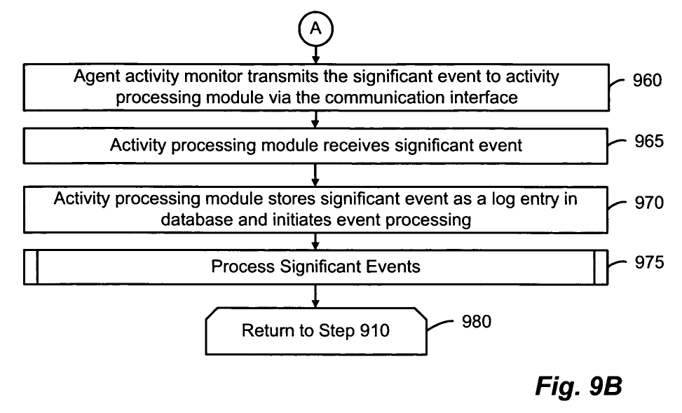

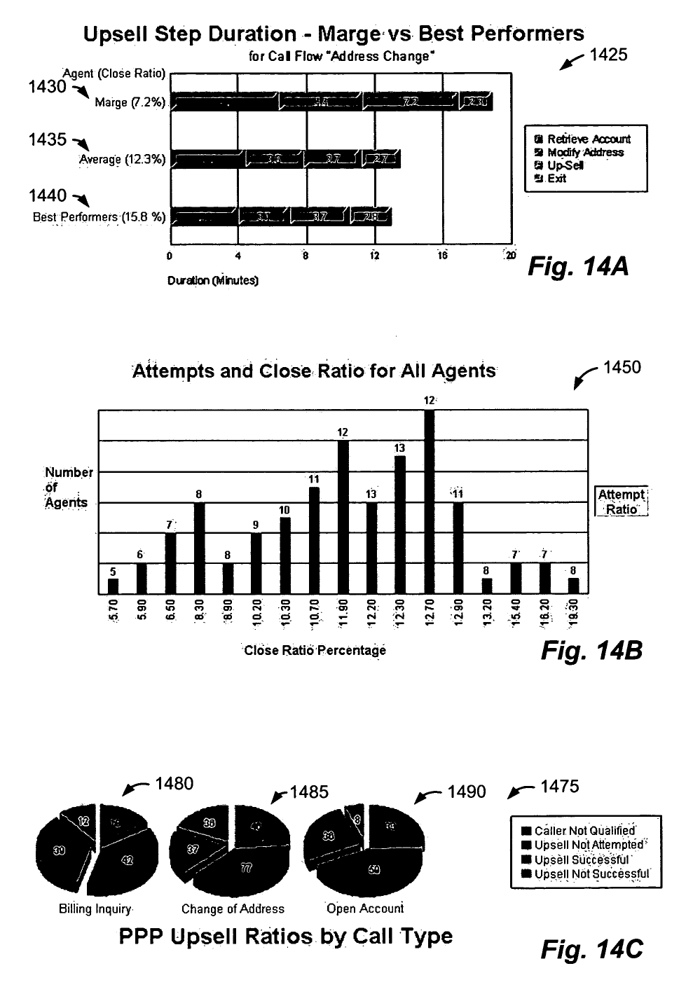

A method and system for improving or enhancing the performance, proficiency, or capabilities of a contact center's workforce will now be described more fully hereinafter with reference to FIGS. 1-15, which show embodiments of the present invention. FIG. 1 provides a block diagram illustration of an exemplary operating environment of an implementation of the present invention. FIGS. 24 provide block diagram illustrations of exemplary implementations of an agent management system that enhances workforce performance. FIGS. 5-8 show exemplary windows of a GUI of the agent management system. FIGS. 9-13 and 15 illustrate flowcharts for exemplary processes involving enhancing workforce performance. FIGS. 14A-C illustrate exemplary reports.

The invention can be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” given herein are intended to be non-limiting, and among other supported by exemplary embodiments of the present invention.

The present invention supports improving workforce performance in a contact center, such as a call center with agents that service inbound caller contacts or make outbound calls to contacts that are prospective customers. In one aspect of the present invention, the agent can interact with a software program, such as an application program, in connection with servicing or processing a contact. The agent can use a mouse, keypad, pointer, microphone, or other input device of a computer to enter information or commands into the computer program via a graphical user interface (“GUI”). The GUI can comprise a computer display or screen that presents visual information or images, graphics, symbols, text, menus, icons, selectable fields, windows, etc. The computer program can receive the agent's input and in response change or update the GUI, for example moving a cursor position, changing a color of a graphical field, or presenting a new view. An operating system of the computer can provide a link or coupling between the program and the computer's screen and input devices. That is, the operating system can function as a communication and processing intermediary between the program and the system components that provide output to and receive input from the agent. The operating system can be a software platform that supports various other software programs and devices. That is, the computer can use the operating system to operate, run or execute various programs or peripherals, such as printers, input devices, disk drives, and display screens. A sensing program can monitor the operating system as it receives output or commands from the program, processes that output, and updates or changes a GUI image at the computer screen. The sensing program can be a tool or program that is commercially available, that is off-the-shelf, or that is adapted from off-the-shelf software. An agent management system can receive output from the sensing program and process that output to ascertain various aspects of the manner in which the agent processes, services, or handles the contact. The sensing program can provide that output to the agent management system in the form of messages that are essentially real-time, thereby providing information with a time delay that is shorter than a human can perceive without the aid of a time measuring instrument.

In another aspect of the present invention, the agent management system can process the output from the sensing program to identify one or more events, steps, or actions that the agent has taken in connection with interacting with the contact. The agent management system can evaluate or categorize those actions and log the ones considered significant. The agent's supervisor can receive notification upon occurrence of an event that warrants his or her attention. That notification can be considered a real-time message. The agent can receive a copy of the notification. The agent management system can determine if an action or a plurality of actions indicates that the agent or the agent's supervisor would benefit from training. As warranted, the agent and/or the supervisor can receive training content at a time that is likely to have a strong positive impact on performance. The agent can receive the training content immediately or after completing a contact episode in which the agent exhibited a need for training and before serving another contact. Training content can comprise tips, coaching, guidelines, reprimands, explanations, information, or simulations, as well as other forms of intervention that can improve an agent's performance or effectiveness.

In another aspect of the present invention, the agent management system can comprise an analytics or processing capability that supports improving workforce performance or effectiveness in the contact center. The agent management system can correlate an agent's performance with one or more steps or actions that the agent has taken in connection with processing one or more contacts. Making that correlation can comprise identifying a step or a pattern, sequence, set, or series of steps taken by one or more agents who achieve strong or desirable performance results. Agents that receive less than strong performance results can receive training aimed at helping them adopt the techniques of the agents that achieve desirable results.

Turning now to FIG. 1, this figure illustrates a system for managing or operating a contact center 100 in which an advantageous embodiment of the present invention is implemented. The contact center 100 includes an arrangement of computer-based components coupled to one another through a set of data links such as a network 165. While some contact center functions are implemented in a single center component, other functions are dispersed among components. The information structure of the contact center 100 offers a distributed computing environment. In this environment, the code that underlies software-based process steps does not necessarily execute in a singular component; rather, such code can execute in multiple components of the contact center 100.

The term “contact center” is used herein to include centers, such as service centers, sales centers, constituent service centers, and call centers that service inbound calls and/or outbound calls. Those calls can be telephone calls or another form of communication. As further described below, a contact center can serve customers or constituents that are either internal or external to an organization, and the service can include audible communication, “chat,” and/or e-mail. A contact center can be physically located at one geographic site, such as a common building or complex. Alternatively, a contact center can be geographically dispersed and include multiple sites with agents working from home or in other telecommuting arrangements.

Although an exemplary embodiment of the invention is described with respect to training an agent in a contact center, those skilled in the art will recognize that the invention may be utilized in connection with training personnel in other operating environments. One example other than a traditional call center environment is a technical support center within an organization that serves employees or members. Those skilled in the art will further recognize that the present invention may be utilized in connection with enhancing workforce performance in a variety of other applications.

The business function provided by a contact center may extend to various communications media or channels and to contacts with constituents of an organization other than customers. For example, an organization may employ an e-mail help desk to provide technical support to its employees. A company may use web-based chat-type systems to provide information to sales prospects. With the expansion of broadband communications infrastructure, many organizations will likely use communications technology for the delivery of multimedia content in connection with contact center operations. Thus, an agent 160 at a contact center 100 might interact with a contact 105 using voice, data, still images, and streaming video during a single service episode.

In one exemplary embodiment, the contact center 100 can comprise a website (not shown in FIG. 1) through which contacts 105 enter or receive information. The website can be a self-service site that can service contacts 105 without agent intervention. Alternatively, the website and the agent 160 can function in a collaborative manner.

In a typical application of the contact center 100, a contact 105, such as a customer or other constituent, calls the contact center 100 via the public switched telephone network (“PSTN”) 110 or other network. The contact 105 may initiate the call in order to sign up for long distance service, inquire about a credit card bill, or purchase a catalog item, for example.

Modern contact centers 100 integrally manage customer phone calls and relevant database information through what is known as a computer-telephone integration system (“CTI”) 140. Two contact center components, an interactive voice response system (“IVR”) 115 and an automatic call distribution component (“ACD”) 130, cooperate with the CTI 140 to acquire information about incoming calls and prepare those calls for subsequent processing in the contact center 100.

The IVR 115 queries each incoming contact 105 to ascertain information such as call purpose, product interest, and language requirements. The IVR 115 typically offers the contact 105 a menu of options, and the contact 105 selects an option by entering a key code or speaking a recognizable phrase.

The ACD 130 detects telephony information from a call without intruding upon the contact 105. The ACD 130 can determine a contact's telephone number and location, for example. The ACD 130 transfers the telephony information to the CTI 140, which references the information to a database and deduces additional information describing the call. The CTI 140 can compare caller location to a demographic database and predict a caller's annual income, for example. The CTI 140 might also identify the caller as a repeat customer and categorize the caller's historical ordering patterns. The CTI 140 typically updates a customer database with newly acquired information so that components of the contact center 100 can handle incoming calls according to up-to-date information.

In addition to acquiring telephony information about a contact 105, the ACD 130 distributes calls within the contact center 100. ACD software generally executes in a switching system, such as a private branch exchange (“PBX”). The PBX connects customer calls to terminals 155 operated by contact center agents 160 who have been assigned to answer customer complaints, take orders from customers, or perform other interaction duties. The ACD 130 maintains one or more queues for holding each incoming call until an agent 160 is selected to take the call and the call is routed to that agent 160. In the case of multiple queues, each queue typically holds a unique category of call so that each caller 105 is placed on hold in exactly one queue. By categorizing queues and placing calls in categorized queues, agents 160 with appropriate expertise can handle each caller's needs in an efficient manner.

Upon receipt of an incoming call from a customer, constituent, or other contact 105, the ACD 130 categorizes the call; selects on the basis of the categorization a specific queue to hold the call; places the call in the specific queue; selects one agent 160 to service the call from a group of agents 160 assigned to service the specific queue; and, by activating a physical switch, routes the call to the selected agent 160. The ACD 130 categorizes the call by applying rules to the information that is known about the call. This categorization can involve assistance from the IVR 115. Based on the categorization, the ACD 130 places the call in one of several queues. In other words, each queue holds a specific category of call. For example, one queue might hold calls from Spanish-speaking callers 105 seeking to order flowers while another queue might hold calls from English-speaking callers 105 seeking to order candy.

A group of agents 160, which are a subset of the total pool of the agents 160 in the contact center 100, services a given queue. An individual agent 160, if appropriately qualified, can service multiple queues. For example, a multi-lingual agent 160 with both candy and flower product skills, might take calls from both of the queues described in the preceding example.

The incoming call waits in a queue until the ACD 130 routes the call to an available agent 160. When the agent 160 receives the call, the agent 160 communicates with the contact 105 and can access or use various systems of the contact center 100 through an agent terminal 155.

In certain embodiments of the invention, the function of the ACD 130 can be replaced by other communications routers. For example, in a contact system 100 using email, an email server and router can distribute electronic messages.

Agent terminals 155 typically include a telephone (not shown in FIG. 1), which is often in the form of a headset, for audible communication with the contact 105 and a computer interface (not shown in FIG. 1) for interacting with the contact center's computer-based systems. The agent 160 accesses information relevant to the call such as product details, customer data, or other information from a database through the computer interface and its associated software.

For example, at a contact center 100 supporting a catalog-based clothing merchant, software executing at the agent terminal 155 could display static information pertinent to a particular contact 105 on a GUI. Such information could include details regarding a specific item of clothing that a customer 105 has expressed an interest in purchasing.

Agents 160 can also view information about the call that the ACD 130 and the IVR 115 compiled when the call first came into the contact center 100. In addition to using the terminal 155 and its associated software to retrieve information, an agent 160 can enter information about the call. For example an agent 160 might use the terminal 155 to complete an order form or document a complaint. Thus, the desktop software application facilitates an agent's interaction with a contact 105 and supports the software-based GUI at the agent's terminal 155. The software application may also interface with, be a component of, or comprise the customer relationship management (“CRM”) component 135. Often, the software application and the CRM component 135 are integrated into a unitary software program.

The CRM component 135 interacts with the CTI 140 and manages customer databases to derive useful information, for example identifying customer purchase patterns. In addition to managing traditional customer information, the CRM component 135 can assess incoming calls, for example to predict the nature of the call or the likelihood of an order. The CRM component 135 conducts this assessment by comparing information acquired from the call to information stored in the center's databases. Such stored information can comprise information from the ACD 130 and the IVR 115 as well as information from other sources. Thus, CRM information can either augment or comprise the information that the ACD 130 obtains about a call.

The contact center's communication network 165 facilitates information flow between the various components of the contact center 100. For a contact center 100 in which all elements are located at the same site, a local area network may provide the backbone for the contact center communication network 165. In contact centers 100 with geographically dispersed components, the communications network 165 may comprise a wide area network, a virtual network, a satellite communications network, or other communications network elements as are known in the art.

A typical contact center 100 includes a workforce management (“WFM”) component 125. The WFM component 125 manages the staffing level of agents 160 in the contact center 100, so that contact center productivity can be optimized from a utilization perspective. For example, the volume of calls into or out of a contact center 100 may vary significantly during the day, during the week, or during the month. The WFM component 125 can receive historical call volume data from the ACD 130 and create work schedules for the agents 160 based on historical activity levels. Thus, the ACD 130 can be a type of activity monitor for the contact center 100 with its historical call volume data predicting periods of high call volume and/or other states of the center 100.

The WFM component 125 typically uses historic data from the ACD 130 to provide a level of service that meets a designated threshold or goal. For example, the WFM component 125 can set a staffing level to provide that 80 percent of calls are answered within 20 seconds, which is a typical service level goal.

In a typical contact center 100, a performance monitoring component 145 provides measurements and indications of agent performance that are useful to management and to the various components in the contact center 100. Performance monitoring typically includes quality monitoring and can entail monitoring recorded calls.

The performance monitoring component 145 may also determine an agent's level of skill and competency in each of several areas by accessing information from the center components that collect and track agent performance information. Examples of these components include the CRM component 135, the workforce performance enhancement system (“WPES”) 120, the WFM component 125, the ACD 130, the agent management system 190, and a quality monitoring system. The relevant skills and competencies for a contact center 100 serving a catalog clothing merchant could include product configuration knowledge (e.g. color options), knowledge of shipping and payment options, knowledge of competitor differentiation, finesse of handling irate customers, and multilingual fluency. The performance monitoring component 145 can store performance-related information from the center's component systems in a dedicated database that is accessible by the ACD 130 for call routing decisions.

In one exemplary embodiment, the performance monitoring component 145 maintains a record of quiz results for each agent 160. Alternatively, the contact center 100 can comprise an e-learning or computer-based training system that maintains test scores. In one exemplary embodiment, such an e-learning system may reside on separate hardware from the WPES 120 and provide distinct functionality.

The WPES 120 can accept performance monitoring input from the performance monitoring component 145 as feedback for agent training programs. The WPES 120, according to one embodiment of the present invention, is implemented in software and is installed on or associated with the communications network 165. The WPES 120 can respond to prompts from the agent management system 190, the performance monitoring component 145, or a human manager at the contact center 100. In response to such a prompt, the WPES 120 can assign training materials to agents 160 and deliver those training materials via the contact center's communication network 165 to an agent's terminal 155.

In one exemplary embodiment of the present invention, the WPES 120 can comprise the software application package that Knowlagent, Inc. of Alpharetta, Ga. markets under the name “Knowlagent r7 Solution.”

Integration with the various components of the contact center 100 enables the WPES 120 to deliver training content to agents 160 at times when those agents 160 are likely to receive significant benefit. Properly timed training can have a strong impact on an agent's performance. The WPES 120 can coordinate the various processes occurring in the contact center 100 to provide an agent 160 time for training without disrupting the contact center 100 or otherwise hindering the contact center's operations. Such training can be administered at a rate or on a schedule that does not degrade the contact center's service level below a designated threshold.

The WPES's connectivity to the performance monitoring component 145 also facilitates delivery of appropriate training materials to the agents 160 who are most in need of training. Proficient agents 160 can be spared the distraction of unneeded training, and training can be concentrated on specific agents 160 having the greatest need and on subject areas relevant to those agents 160. Contact center management may establish pass/fail or remediation thresholds to enable the assignment of appropriate training to appropriate agents 160. The performance monitoring component 145 may provide or otherwise support this functionality. Agent skills that are found to be deficient relative to the thresholds can be flagged and stored in a storage device within the performance monitoring component 145.

In one embodiment of the present invention, the performance monitoring component 145 is a system that is physically dispersed in the contact center 100. In this configuration, the performance monitoring component system 145 can include the system components in the contact center 100 that contain agent performance information such as average handling time, close ratio, quality, etc. The WPES 120 can use the performance monitoring data to ascertain the performance gaps that exist for one or more agents 160 and assign training to address those gaps. One or any combination of performance metrics can be analyzed to determine a need for training. For example, if an agent's revenue per call is unacceptable, then the WPES 120 might assign remedial sales training.

The WPES 120 can assess various aspects of an agent's qualifications. By administering a traits test, the WPES 120 characterizes an agent's personality and cognitive abilities. The WPES 120 typically administers a traits test only once for each agent 160, since for most agents 160, cognitive ability and personality do not change dramatically during employment. In other words, traits can reflect innate aptitude.

In addition to assessing traits, the WPES 120 can identify knowledge gaps that training or coaching can fill. By administering a skills and competencies test, the WPES 120 can identify knowledge gaps and determine agent qualifications that improve with training and on-the-job experience.

With an understanding of each agent's skills and competencies, administered training can improve those skills and competencies. After receiving training, an agent 160 can undergo an assessment to ensure the agent 160 understood and retained the information. In addition, the agent's performance can be monitored to determine if performance has changed based upon the acquisition of the new information. When the agent's performance has changed, the WPES 120 can automatically update the agent's skills and competencies, maintaining a current view of agent qualifications.

In tandem with or as an alternative to the performance monitoring component 145, the WPES 120 or the agent management system 190 can determine if an agent 160 effectively practices the subject matter of a completed training session. Immediately following a computer-administered test, the WPES 120 can make test results available throughout the contact center's information network infrastructure 165.

In addition to testing agents 160 and providing conventional training materials, the WPES 120 can simulate interactions between an agent 160 and a contact 105. Simulated interactions can include demonstrations of model interactions between an agent 160 and a contact 105. A software program can simulate the agent 160, the contact 105, and the functions of the computer interface at the agent terminal 155 along with the interaction steps between those elements. Simulated interactions can also include the WPES 120 performing the role of the contact 105 and providing a trainee agent 160 with a learning experience of interacting with a simulated contact. In this scenario, the WPES 120 can provide assistance and coaching to assist the trainee agent 160 in learning to process a contact 105 using procedures and techniques that the contact center's management considers best practice. The WPES 120 can also record the simulated activity for later review, playback, and coaching or training.

As will be discussed in more detail below, the agent management system 190 monitors an agent's behavior while the agent 160 services each contact 105 and provides monitoring information during or immediately following a live service episode or session. If warranted by an agent's behavior while servicing a contact 105, the agent management system 190 may prompt the WPES 120 to deliver training content to the agent 160 at a specified or selected time. That selected time can be after the agent 160 finishes servicing a current contact 105 and prior to the agent 160 servicing another contact 105. In other words, the agent 160 can receive training immediately following a service episode during which the agent 160 acted in a manner that deviated from the contact center's best practices. Such training can comprise a tip, a notification, a long or short course, a warning, or another intervention intended to enhance performance. If the contact center 100 is too busy, then training or coaching can be scheduled for a later time.

In one exemplary embodiment, the nature of the agent's behavior is a factor in determining whether to deliver the training immediately following a contact episode or at some future time. That decision can turn on whether the behavior meets a criterion as determined by an application of one or more rules to that behavior.

The agent management system 190 can also prompt the WPES 120 to send training content to the agent's supervisor 175 when one or more agents 160 exhibit behavior that indicates that the supervisor 175 would benefit from training. For example, a supervisor 175 may receive a tip for motivating an agent 160 or a guideline for becoming a better coach. The WPES 120 delivers such training to the supervisor 175 on the supervisor station 180, which comprises a computer display (not labeled in FIG. 1).

In one exemplary embodiment, the agent management system 190 monitors or senses significant events occurring on the supervisor station 180 as well as on the agent terminals 155. In this embodiment, the agent management system 190 can initiate delivery of training content to the supervisor 175 based directly on the supervisor's interaction with application software on the supervisor station 180. The agent management system 190 can provide a similar function for the other personnel that comprise the workforce of the contact center 100. For example, the agent management system 190 can monitor the members of the contact center's finance department as each member interacts with accounting software. When warranted by an analysis of those interactions, the agent management system 190 can prompt the WPES 120 to send training to a specific member of the finance department, a department manager, or the full department.

Those skilled in the information-technology, computing, or contact center arts will recognize that the components, data, and functions that are illustrated as individual blocks in FIG. 1 and the subsequent figures discussed below are not necessarily well defined modules. Furthermore, the contents of each block are not necessarily positioned in one physical location of the contact center 100. In one embodiment of the present invention, the blocks represent virtual modules, and the components, data, and functions are physically dispersed. For example, in one embodiment of the present invention, a library of training content can be stored on a single computer readable medium located offsite of the contact center 100. In one embodiment of the present invention, a single computer readable medium, such as a hard drive, can store rules associated with processing monitored agent information. A single microprocessor can execute software code underlying such rules. In yet another embodiment, multiple contact center components each performs one or more aspects of identifying circumstances or agent behavior that should be addressed with training. In general, the present invention can include processes and elements that are either dispersed or centralized according to techniques known in the computing or information-technology (“IT”) arts.

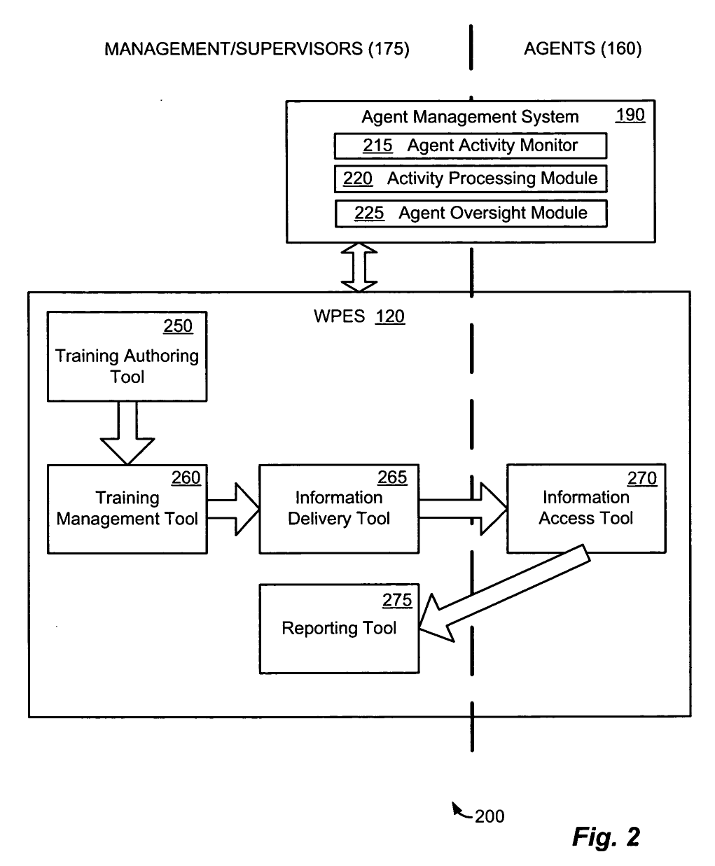

Turning now to FIG. 2, this figure illustrates a functional block diagram of an exemplary system 200 for improving workforce performance in a contact center 100 in accordance with an embodiment of the present invention. That system 200 comprises the WPES 120 and the agent management system 190, both of which connect or couple to the agents 160 and one or more supervisors 175.

The WPES 120 comprises a number of interoperable tools, software modules, or programs, each of which can have a configuration customized according to a specific contact center's needs. The training authoring tool 250 is a software module that enables the managers of a contact center 100 to develop training materials, training courses, training quizzes, training content, coaching tips, and other information intended to improve workforce performance.

The WPES 120 further comprises a training management tool 260 that enables contact center supervisors 175 or an automated/computer-based system to manage various aspects of the training processes. For example, a supervisor 175 can use the training management tool 260 to divide the contact center's agent population 160 into groups. Each group might be a set of agents 160 with similar work schedules, training needs, or skill levels. A specific group or a superset of groups can receive common training content under a coordinated time schedule, for example.

The information delivery tool 265 can specify an appropriate time to deliver assigned training materials to one or more agents 160. The information delivery tool 265 can receive agent workload data and contact center load data from the ACD 130 through the CTI 140. The WFM component 125 can provide the information delivery tool 265 with a work schedule for agents 160.

In one exemplary embodiment of the present invention, the information delivery tool 265 receives from the agent management system 190 a preferred time for delivering training content to an agent 160. To meet a request for scheduling a training session, the information delivery tool 265 can coordinate activities or processes in the contact center 100 to provide the agent 160 with a training timeslot at the requested time.

For example, the agent management system 190 might determine that a training session would be most effective if it followed a call during which an agent 160 did not comply with one of the contact center's preferred practices. Via coordination with other computer-based systems or personnel in the contact center 100, the information delivery tool 265 could arrange training time for the agent 160 after that call and before the agent 160 begins servicing another contact 105.

The information access tool 270 comprises the software and graphical interfaces through which an agent 160 accesses content. The information access tool 270 can comprise a window, a dedicated screen, or a pop-up character that dispenses advice, tips, coaching, training, warnings, etc. on an agent terminal 155. In one exemplary embodiment, the information access tool 270 provides e-mail-based information intended to enhance workforce performance. The information access tool 270 may use a web server to provide training or coaching through a browser.

The reporting tool 275 tracks each agent's consumption of training and quiz results. For example, the reporting tool 275 can generate reports detailing the training materials that each agent 160 has received. Such reports may be standardized or customized according to a supervisor's preference.

The WPES 120 and its various software tools or modules interact with the agent management system 190. In one exemplary embodiment, the agent management system 190 provides a supervisory role over the WPES 120. That is, the agent management system 190 sends prompts, commands, requests for action, instructions, etc. to the WPES 120. Thus, the agent management system 190 can implement various functions or actions by invoking the WPES 120 to perform one or more tasks. The WPES 120 typically responds to requests from the agent management system 190 through its software modules, which as described above can comprise the tools 250, 260, 265, 270, 275 illustrated in FIG. 2 and discussed above. Furthermore, the WPES 120 can respond to a request from the agent management system 190 by calling other components, software or hardware, of the contact center 100 to perform actions.

The agent management system 190 comprises three exemplary components, the agent activity monitor 215, the activity processing module 220, and the agent oversight module 225 that FIG. 2 illustrates. A copy or instance of the agent activity monitor 215 resides on each agent's terminal 155. From this position, the agent activity monitor 215 obtains information about events, steps, actions, or activities that each agent 160 has taken in connection with processing a respective contact 105. This information provides a basis for determining whether the agent 160 complies with the contact center's best practices and procedures for servicing contacts 105. In response to noncompliance, the agent management system 190 can trigger or engage the WPES 120 to deliver training content to an agent 160 at an effective time.

The activity processing module 220 executes on a server (not shown on FIG. 2) that processes or handles information that the agent activity monitor 215 provides. As an output of processing information from the agent activity monitor 215, the activity processing module 220 identifies significant events that the agent 160 has taken in connection with servicing a contact 105. In other words, the activity processing module 220 identifies an agent's behavior that is believed to be linked to successful or unsuccessful contact service. For example, the activity processing module 220 can identify a successful sale, a missed cross-selling opportunity, up-selling data, a call closing, a breach of established protocol, etc. based on information from the agent activity monitor 215.

The activity processing module 220 comprises a set of business rules that it applies to the information from the agent activity monitor 215. The business rules can categorize the agent's behavior and, when warranted, initiate the WPES 120 to assign training content to the agent 160, the agent's supervisor 175, or another member of the contact center's workforce.

The agent oversight module 225 resides and executes at the supervisor station 180, typically on a personal computer (“PC”). The supervisor 175 interacts with the agent oversight module 225 to effectively manage, supervise, or coach the agents 160 with a goal of enhancing workforce performance. The agent oversight module 225 can provide the supervisor 175 with information about the agent's behavior that is pertinent to achieving contact center results. For example, the agent oversight module 225 can generate reports detailing sales events, instances in which an agent 160 did not comply with accepted procedures, training breaks, assignments of training materials, actions that an agent 160 repeated, and general information describing the steps that an agent 160 has taken.

In one exemplary embodiment of the present invention, each agent terminal 155 remotely accesses software from a central server. Such remote access reduces the hardware requirements and cost of each terminal 155. That is, each agent terminal 155 and supervisor station 180 can comprise a network computer or a Net PC, sometimes referred to as a thin client, with the majority of the data processing occurring at the server. Citrix Systems of Fort Lauderdale, Fla. sells infrastructure software that supports this type of architecture. In this embodiment, one or more Citrix servers can implement some or essentially all of the functions of the agent management system 190. For example, each session on a Citrix server can have an accompanying agent activity monitor 215.

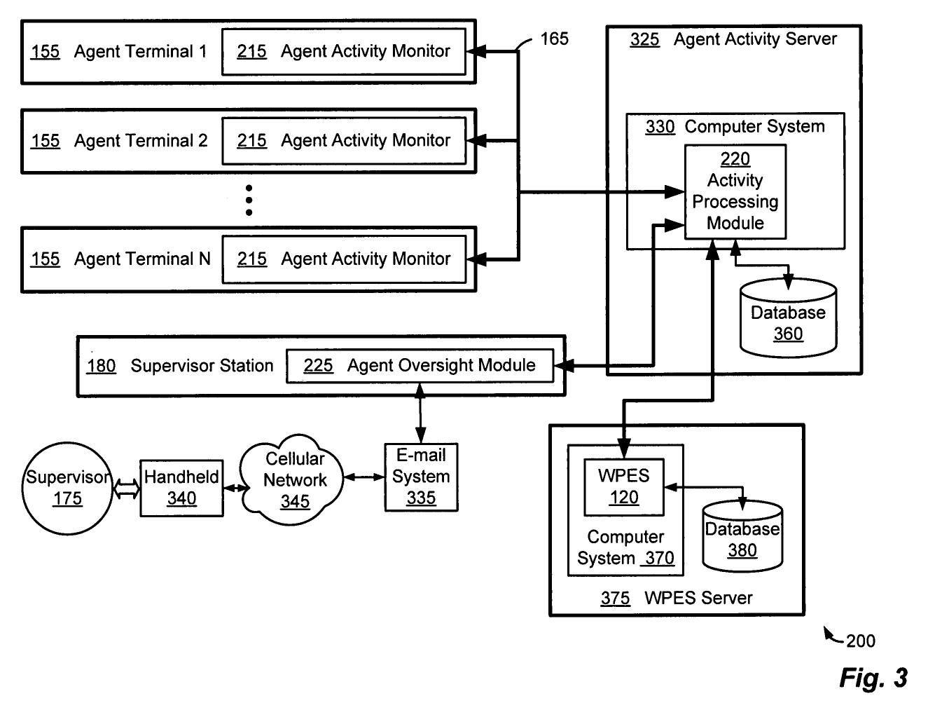

Turning now to FIG. 3, this figure illustrates a functional block diagram of an exemplary configuration of a system 200 for improving workforce performance in a contact center 100 in accordance with an embodiment of the present invention. As discussed above, each agent terminal 155 executes a software copy or load of the agent activity monitor 215. During the software installation process, the agent activity server 325 or the WPES 120 can push a copy of the agent activity monitor 215 out to each agent terminal 155 using the contact center's information network 165. Following this push, the agent activity monitor 215 resides on each agent's terminal 155 and tracks activities thereafter.

The agent activity server's hardware comprises a computer system 330 and a data storage device that holds a database 360. The computer system 330 can be a PC or a form of computer optimized for server operation, for example. The database 360 maintains a record of significant events that the activity processing module 220 noted or identified as discussed above.

The WPES 120 resides on and executes from a dedicated server 375 that comprises a computer 370 and a database 380. The database 380 stores training content, test scores, and other training-related data.

The agent oversight module 225 can be configured to interact with the supervisor 175 via a cellular network 345 and an e-mail system 335 when the supervisor 175 is away from the supervisor station 180. The supervisor 175 can configure the agent oversight module 225 to output an e-mail notification related to an agent 160 performing a significant event such as an act of noncompliance. Thus, a noncompliant act can be a trigger for sending the notification. The supervisor 175 can receive such e-mail notifications or status updates via an e-mail-enabled handheld device 340 such as a cellular telephone with e-mail capabilities or a handheld computer that communicates via a wireless medium.

The e-mails can provide the supervisor 175 with specific managerial information while the supervisor 175 is away from the supervisor station 180. With this freedom, the supervisor 175 can receive notifications and pertinent managerial information while moving about the call center 100, for example having face-to-face interactions with individual agents 160. Such mobility and personal interactions help the supervisor 175 function as a coach to the agents 160. Further, the supervisor 175 could receive managerial information while off the premises of the contact center 100, for example attending an offsite meeting.

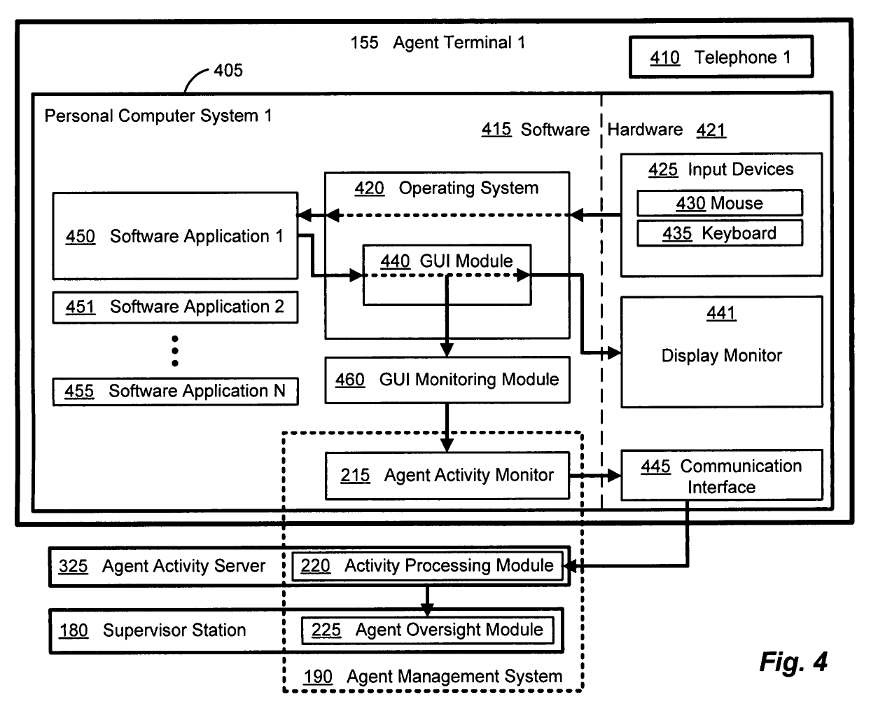

Turning now to FIG. 4, this figure illustrates a functional block diagram of an exemplary agent terminal 155 coupled to a system 190 for improving workforce performance in accordance with an embodiment of the present invention. The agent terminal 155 comprises a telephone 410 and a PC system 405. The PC 405 and the telephone 410 can be distinct hardware components. In one exemplary embodiment, the telephone 410 can communicate via voice-over-Internet-protocol (“VoIP”). The PC 405 can also comprise a soft phone in which the telephone's functionality is integrated into the PC 405, resulting in a unitary structure.

The PC 405 comprises hardware 421 and software 415. The PC's hardware can comprise typical computer components such as disk storage, disk drives, microphones, random access memory (“RAM”), read only memory (“ROM”), one or more microprocessors, power supplies, a video controller, a system bus, a display monitor 441, a communication interface 445, and input devices 425. FIG. 4 illustrates several such components.

The PC 405 executes software comprising an operating system 420 and one or more software applications 450, 451, 455. The operating system 420 can be the software product that Microsoft Corporation of Redmond, Wash. sells under the registered trademark WINDOWS.

The term “software application” or “application software” is used herein to refer to one or more computer programs or pieces of computer executable code. The use of that term is not intended to limit the scope of the present invention to any specific types of software programs. To name a few examples, a software application can comprise one or more of a utility, a module or object of code, a software program, an interactive program, a “plug-in,” an “applet,” a script, a “scriptlet,” an operating system, a browser, an object handler, a standalone program, a language, a program that is not a standalone program, a program that runs a computer, a program that performs maintenance or general purpose chores, a program that is launched to enable a machine or human user to interact with data, a program that creates or is used to create another program, and a program that assists a user in the performance of a task such as database interaction, word processing, accounting, or customer relationship management. Thus, the software application 450 can comprise one or more of those software items. In one exemplary embodiment discussed herein, the software application 450 supports the agent 160 in servicing a contact 105 and provides the agent with an interface to interact with data related to a service episode that the contact center 100 maintains.

The software application 450 interfaces with the operating system 420 and in particular the operating system's GUI module 440. The GUI module 440 receives instructions from the software application 450 and provides output to the display monitor 441. The display monitor 441 presents the output graphically on the display monitor 441 in accordance with those instructions. Thus, the software application 450 can cause the display monitor 441 to show call scripts, forms, product pictures, pricing information, product specifications, menus, contact information, customer management information, cross selling opportunities, timers, or other information that the agent 160 uses to service a contact 105. In connection with this information, the monitor 400 typically displays text and active graphics, including buttons and menu commands.

The agent 160 uses the input devices 425 while servicing a contact 105 to enter information into the software application 450 or one or more of the call center's computer based systems. The input devices 425 can comprise a pointing device such as a mouse 430 or trackball, a keyboard 435, a touch screen, or a microphone that receives audible input or voice commands. The agent 160 inputs call information, sales orders, shipping information, complaint specifics, etc. via one or more of the input devices 425.

The agent 160 may gesture with the mouse 430 to position a cursor over a specific patch of the GUI, designated with an appropriate “purchase” graphic, and “click” to register a contact's order for a product, for example. The mouse 430 generates signals that the operating system 420 recognizes. The operating system 420 in turn informs the software application 450 of the mouse movement, for example using a two-dimensional coordinate system, and the agent's click. By comparing the received coordinates of the click to coordinates of the purchase graphic, the software application 450 might interpret the agent's mouse click as a product order for the contact 105, for example.

In coordinated function with the software application 450, the GUI module 440 sends output to the display monitor 441 updating the cursor movement across the screen as the agent 160 moves the mouse 430. Thus, the GUI module 440 provides a standardized interface or intermediary between the software applications 450, 451, 455 and the display monitor 441.

The GUI monitoring module 460 is a software program that ties, hooks, peers, or links into the GUI module 440 to access communications between the software application 450 and the display monitor 440. That is, the GUI monitoring module 460 obtains dynamic data from the GUI module 440 in a standardized format that describe the software application's interaction with the display monitor 441. Since the agent 160 processes the contact 105 using the GUI of the software application 450, that dynamic data also describe the steps that the agent 160 has taken in connection with processing the contact 105.

U.S. Pat. No. 6,340,977, entitled “System and Method for Dynamic Assistance in Software Applications Using Behavior and Host Application Models” and filed on May 7, 1999 discloses technology for hooking into an operating system and extracting information about a user's interactions with a software application. The GUI monitoring module 440 illustrated in FIG. 4 can comprise technology disclosed in U.S. Pat. No. 6,340,977. That is, in one exemplary embodiment of the present invention, the GUI module 440 can be based on the disclosure or teaching of U.S. Pat. No. 6,340,977. The entire disclosure of U.S. Pat. No. 6,340,977 is hereby incorporated by reference.

In one exemplary embodiment of the present invention, the GUI monitoring module 460 comprises the software product that Knoa Software, Inc. of New York, N.Y. sells under the product name “Knoa Client Engine.”

The agent activity monitor 215 of the agent management system 190 receives and processes the information that the GUI monitoring module 460 tracks, monitors, or acquires from the GUI module 440. The agent activity monitor 215 filters the information from the GUI monitoring module 460 to identify occurrences of agent events of potential relevance to contact processing or agent performance.

For example, the GUI module 440 may generate output when the agent 160 translates the cursor across the screen using the mouse 430 as discussed above. Cursor movements alone are typically not considered significant to the agent's methodology for processing a contact 105. Thus, the agent activity monitor 215 typically ignores cursor movements that are not accompanied by an event of greater significance, such as clicking on a purchase button or soft key or on a menu item. Events that may be considered relevant to the steps that an agent 160 has taken in connection with servicing a contact 105 can include ending a call, closing a sale, changing pages in a screen, moving between software modules, applications, or programs, entering data into a form, cross selling a product, attempting an upgrade sale or up-sell, receiving a software error, taking a learning break, which is a not an exhaustive list.

The agent activity monitor 215 sends each monitored event that it deems relevant to the activity processing module 220 at the agent activity server 325. Communication between the activity processing module 220 and the agent activity monitor 215 flows through a communication interface 445 or port on the PC system 405.

The activity processing module 220 subjects the filtered events to a layer of processing that can include categorization or classification of events. Such processing can also comprise event-to-event correlations, correlating an event with a cause of the event, and correlating an event with a result. Thus, the activity processing module 220 can identify relationships between causes and effects. The activity processing module 220 determines whether an agent's click of a mouse 430 corresponds to the agent 160 closing a sale, logging off, or ending a call, for example. As will be discussed in further detail below, the activity processing module 220 assesses each event to determine whether it indicates a need for training or for another performance intervention.

In addition to evaluating events, the activity processing module 220 processes multiple events to identify event patterns of potential relevance to the performance of the contact center's workforce. For example, the activity processing module 220 might determine that a specific agent 160 has performed a positive or negative action during a timeframe. An agent 160 might have missed two cross-selling opportunities during an hour, while another agent 160 closed three sales in fifteen minutes. In this manner, the activity processing module 220 can combine or group a plurality of events that may or may not be individually significant into a unified significant event.

Using pattern identification, the activity processing module 220 can isolate agent behavior patterns that either have a negative or positive impact on the business performance of the contact center 100. The WPES 120 can teach the behavior patterns that have a positive impact to other agents 160. On the other hand, the WPES 120 can deliver training content aimed at changing or correcting negative behavior.

In response to detecting various forms of agent behavior, the activity processing module 220 can elect to initiate a training session as discussed above or provide notification to the supervisor 175 via the agent oversight module 225.

While illustrated as separate elements in FIG. 4, in one exemplary embodiment of the present invention, one or more of the software applications 450, 451, 455, the operating system 420, the GUI module 440, the GUI monitoring module 460, the agent activity monitor 215, the activity processing module 220, and the agent oversight module 225 can be combined into an integrated package or module of software. For example, the software application 450 can provide an operating system functionality that runs the PC 405, with the GUI monitoring module 460 tapping into that functionality to identify candidate events.

In one exemplary embodiment of the present invention, the agent management system 190 identifies or processes events based on speech patterns. That is, the agent management system 190 can comprise, or collaborate with a module that comprises, speech recognition software. The speech recognition software can identify and process speech, voice, or word patterns occurring in dialogue between the agent 160 and the contact 105 that either or both of the contact 105 and the agent 160 articulate. In addition to spotting a single word, such software can reveal patterns of multiple words, phases, or sentences spoken by one or both people.

During a call, the agent management system 190 can use such speech recognition capabilities for real time speech analytics to uncover events or actions that may be relevant to training or managing an agent 150 or another member of the contact center's workforce. Speech processing can proceed in parallel with the operations of the GUI Module 440 and the GUI Monitoring Module 460 so that speech-derived information augments information obtained via the operating system 420. Alternatively, speech processing can provide a separate or distinct window into the agent's interactions with the contact 105.

Exemplary embodiments of the present invention can include commercially available speech analytics tools or software products, such as the Speechworks product of ScanSoft, Inc. of Peabody, Mass. and products available from Nexidia, Inc. of Atlanta, Ga.; Nuance Communications, Inc. of Menlo Park, Calif.; and CallMiner, Inc. of Cape Coral, Fla.

Exemplary displays available on the supervisor station 180 will now be discussed with reference to FIGS. 5-8.

FIGS. 5A, 5B, and 5C illustrate exemplary configuration screens or windows 500, 550, 575 of a GUI for a contact center supervisor 175 in accordance with an embodiment of the present invention. Through these windows 500, 550, 575, the supervisor 175 can set up or edit the criteria that the activity processing module 220 applies to events from the agent activity monitor 215 to determine whether any events warrant supervisor notification or other action.

FIG. 5A illustrates a configuration window 500 for viewing criteria for receiving event notifications regarding categorized events. The field 505 allows a supervisor 175 to enter a personal identification, such as a name or a password, so that the agent oversight module 225 can update the window 500 to reflect each supervisor's personal preferences.

The exemplary window 500 illustrates entries for error-based notifications 510 and entries for compliance-based notifications 530. The supervisor 175 can elect to edit or delete a notification criterion 510, 530 or to add a new criterion. That is, the supervisor 175 can populate the parameter fields of a notification template using either default or custom values. In one exemplary embodiment, the notification templates themselves can be customized to meet a specific contact center's individual needs.

Each error entry 510 shows the number of times 520, such as once or twice, in a specific period of time 525, such as five minutes or one hour, that an agent 160 needs to encounter the error to trigger a supervisor notification. An error can occur when the software application 450 outputs a message informing the agent 160 of an entry mistake. For example, notification may occur if an agent 160 receives an error such as “invalid phone number entered” more than two times in a ten-minute period.

Each compliance entry 530 shows a set of conditions for meeting a noncompliance notification. A noncompliance that triggers such a notification can comprise an agent 160 processing a contact 105 in a manner that deviates from an approved practice or guideline of the contact center 100. For example, the activity processing module 220 can note a noncompliant event when an agent 160 performs a specified operation a designated number of times 535 during a selected time interval 540. As another example, the supervisor 175 may elect to receive notification each time that an agent 160 fails to activate a cross-selling screen in the course of processing a contact 105.

The supervisor 175 can add new event notification rules via the “Add New” field 545 which calls the window 550 that FIG. 5B illustrates. The supervisor 175 can enter detailed notification criteria into the various fields of the window 550. That is, the window 550 provides a template for establishing business rules relevant to an agent 160 processing a contact 105.

After entering the desired criteria into the template window 550, the supervisor 175 can move to the window 575 that FIG. 5C illustrates. Via the window 575, the supervisor 175 can select one or more specific agents 160 for monitoring. The window 575 includes a “Select Agents” field 580 and an “Unselected Agents” field 585. The actions of the agents 160 whose names appear in the selected field 580 are subjected to the monitoring or notification rules that the supervisor 175 configured via the window 550. The supervisor 175 ordinarily does not receive notification for the actions of agents 160 listed in the unselected field 585. Thus, the supervisor 175 can elect to closely monitor specific agents 160 while monitoring other agents 160 less closely. For example, the supervisor 175 may elect to ignore certain routine errors that an experienced agent 160 may receive while closely monitoring a newly hired agent 160. In other words, the supervisor 175 can use the window 575 to monitor selected agents 580 without monitoring other agents 585, thereby providing control over which agents 160 are being watched for certain types of actions.

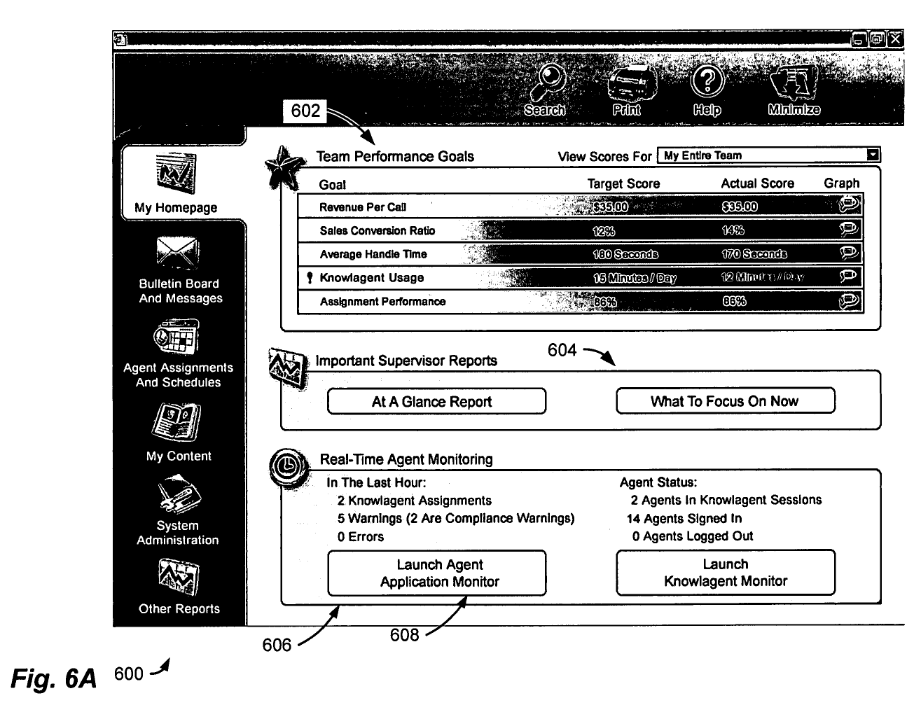

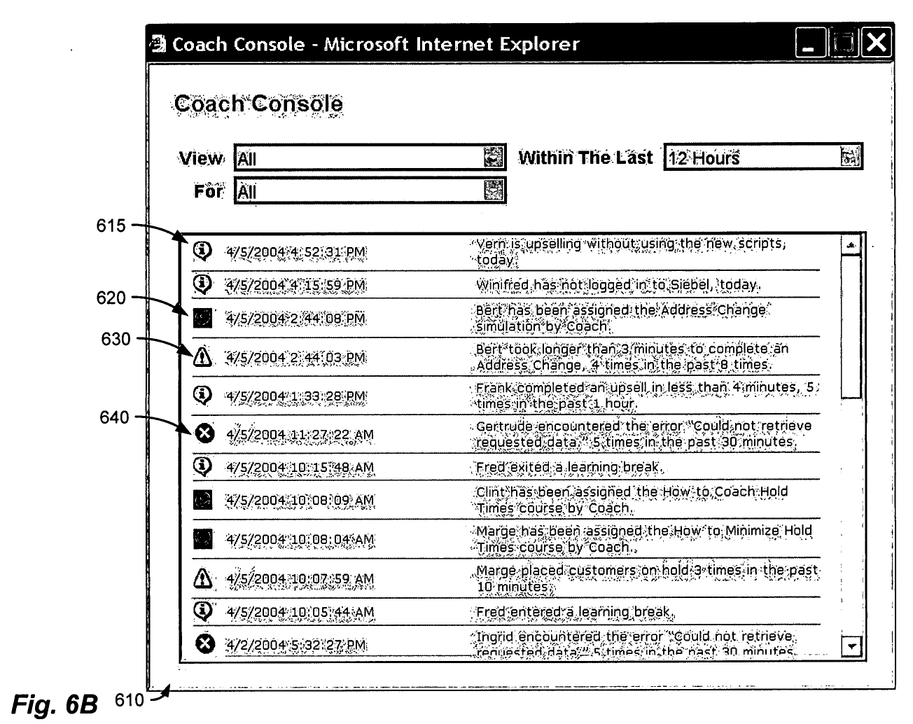

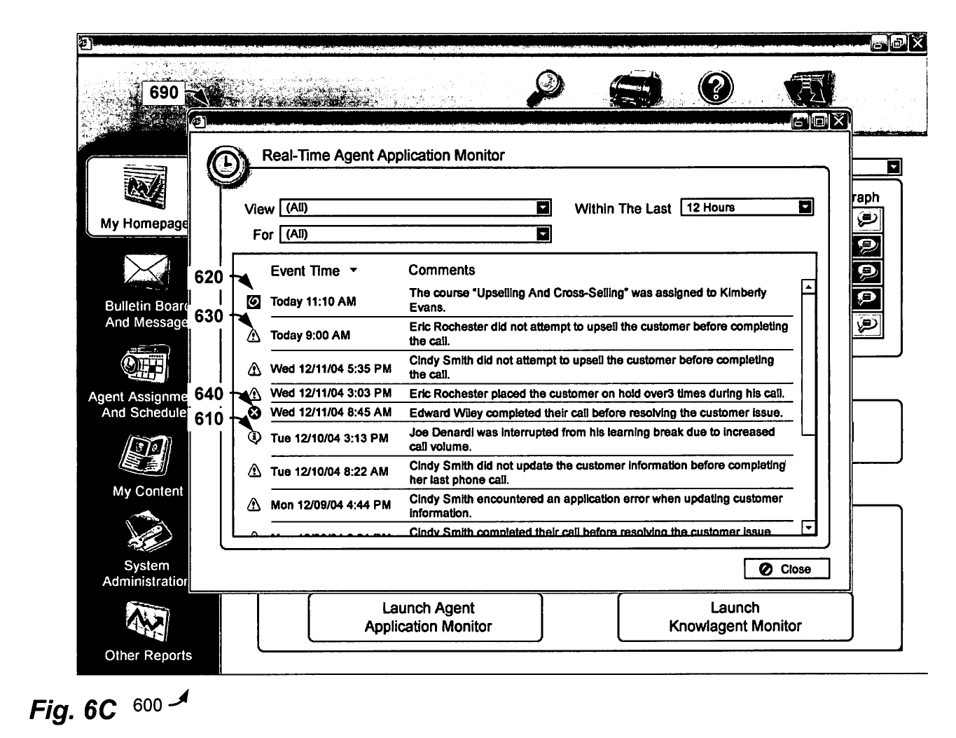

Turning now to FIGS. 6A-C, these figures illustrate user windows 600, 610 of an exemplary GUI for a contact center supervisor 175 in accordance with an embodiment of the present invention. The supervisor station 180, which can be viewed as a console for coaching agents 160, provides these windows 600, 610 to offer the supervisor 175 dynamic or real-time information regarding the activities and performances of the agents 160 under his or her supervision.

The window 600 is an example of a base or root window through which the supervisor 175 can navigate to various GUI windows that facilitate interaction with the agent management system 190 and the WPES 120 and provide managerial support.

The section 602 presents the supervisor 175 with aggregate statistics regarding the agents 160 that he or she manages. The supervisor 175 can generate reports through the section 604 of the window 600. FIGS. 14A-C illustrate exemplary reports, as discussed below.

The section 606 provides an interface to the agent management system 190 and presents summary information from that system 190. Through the button 608, the supervisor 175 can launch the agent application monitor window 610, 690 that FIGS. 6B and 6C illustrate in two exemplary embodiments. Thus, selecting the button 608 takes the supervisor to the window 610 or causes the window 690 to popup.

The window 610, shown in FIG. 6B, provides the supervisor 175 with an interactive list of significant events. As illustrated, the window 610 displays the events in chronological order for all agents 160. Alternatively, the supervisor 175 can elect to display events for a specific agent 160 or for a specific category of events.

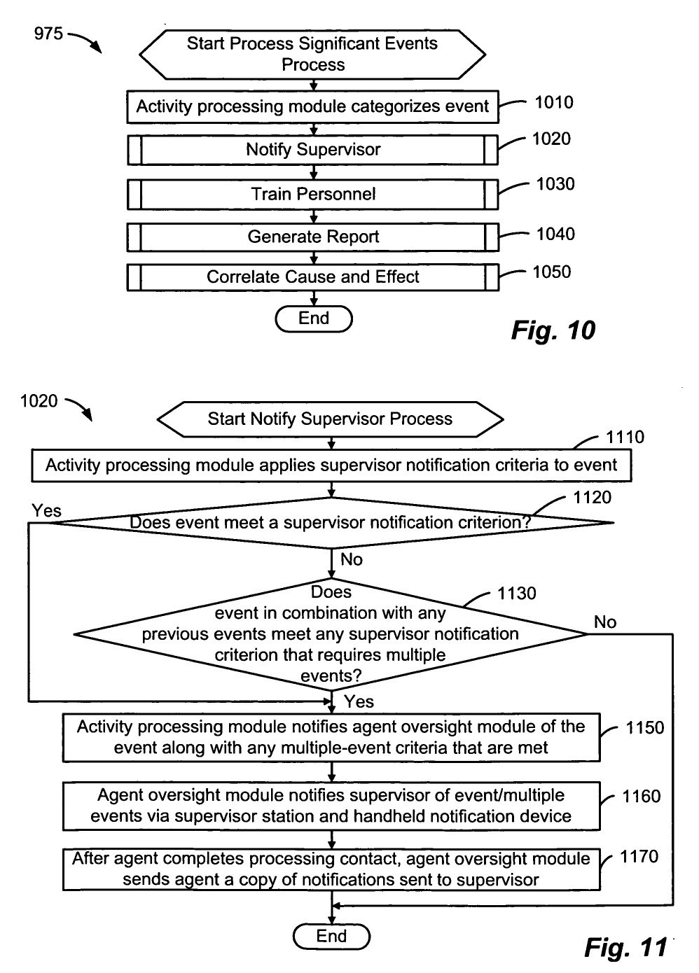

Each event is listed along with a graphic, icon, or symbol 615, 620, 630, 640 that designates that event's category. The contact center 100 can customize the icons 615, 620, 630, 640, either in form or in the type of event that each designates, according to managerial preference. As will be discussed below in further detail with reference to FIG. 10, the activity processing module 220 can designate each event as being informational, training, noncompliance, or error alert, which are exemplary designations.

The symbol 615 provides a visual indication that an event is informational. The symbol 620 indicates that an agent 160 has received a training assignment. The symbol 630 shows that the event involves a noncompliance issue or constitutes an act of noncompliance. The symbol 640 indicates that an agent 160 has made an error that qualifies as an event.

FIG. 6C illustrates a popup window 690 that displays events and icons 610, 620, 630, 640 that designate each event's assigned category. When the popup window 690 appears, the base window 600 remains present in the background.

Turning now to FIG. 7, this figure illustrates a monitoring window 700 of an exemplary GUI for a contact center supervisor 175 in accordance with an embodiment of the present invention. The supervisor 175 can view the window 700 on the supervisor station 180 to access dynamic data that provides managerial assistance or support. The window 700 has a split view that shows call information above 725 and alert notifications below 750. The alert notifications section 750 can provide similar or essentially the same information as the window 610 illustrated in FIG. 6 and discussed above.

The call information section 725 shows the supervisor 175 the current status or most recent activity for each agent 160 under supervision. The supervisor 175 can observe the length of each in-progress call, the current screen, and call type or purpose for each agent 160. The information that the window 700 presents can be updated on a real-time or near real-time basis. In one exemplary embodiment, the information is refreshed or updated at least once during each contact episode. The information can be updated on an event or time basis, such as every second, minute, two minutes, three minutes, ten minutes, etc. or in a range thereof.

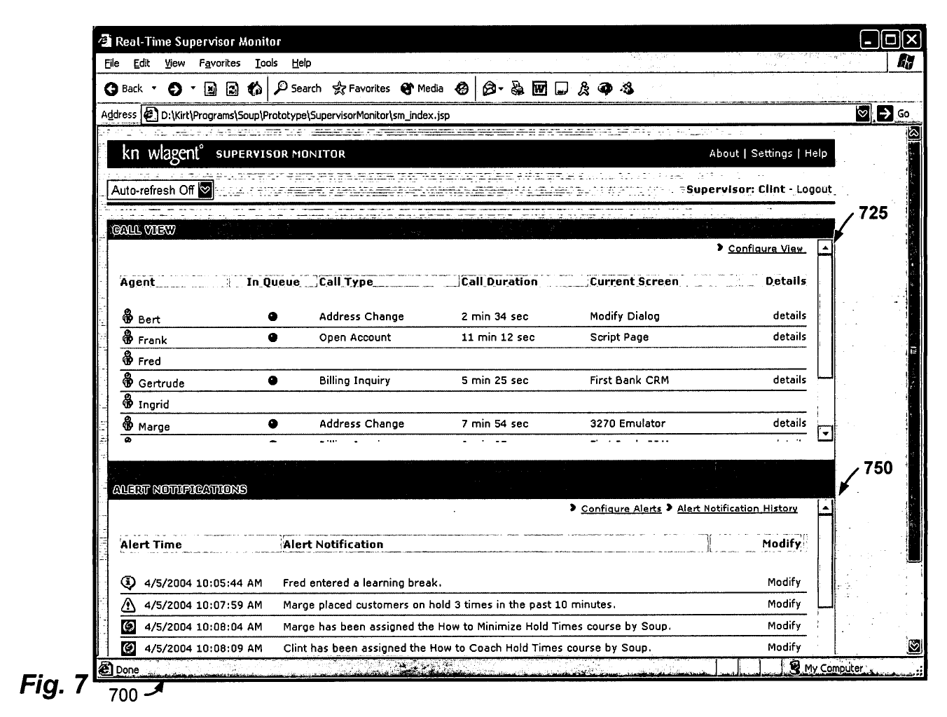

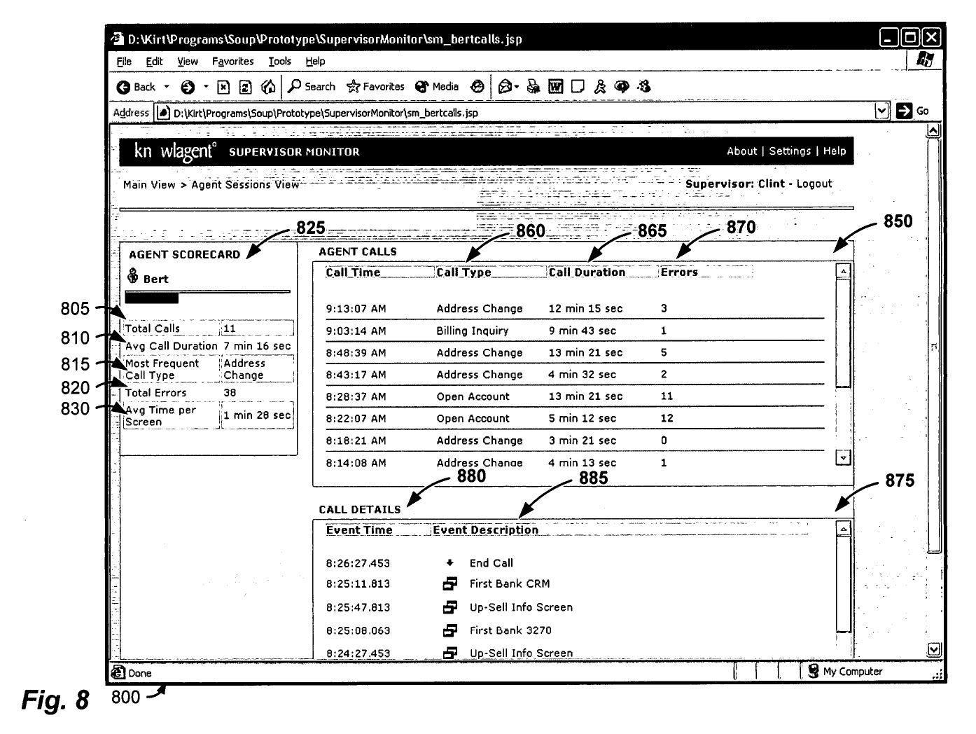

Turning now to FIG. 8, this figure illustrates an agent detail window 800 of an exemplary GUI for a contact center supervisor 175 in accordance with an embodiment of the present invention. The window 800 provides the supervisor 175 with dynamic information regarding any agent 160 that the supervisor 175 selects. A user can transition to the window 800 by clicking on a specific agent's name in the window 700. A supervisor 175 might access the window 700 to obtain a more detailed or holistic view of an agent 160, for example.

The window 800 comprises three sections 825, 850, 875 to support supervising each agent 160. The agent scorecard section 825 shows the total number of calls 805 that a selected agent 160, for example “Bert,” has processed during the present shift as of the current time. Via that section 825, the supervisor 175 can observe additional metrics of Bert's performance, such as average call duration 810, most frequent call types 815, a count of committed errors 820, and the average amount of time 830 spent on each screen of the software application 450.

The agent calls section 850 provides the supervisor 175 with information in a time-log format regarding each call that Bert processed. The information includes the type or general nature of each call 860, the duration of each call 865, and the number of errors that Bert committed during each call 870.

When the supervisor 175 clicks on a particular call listed in the window 850, the call details section 875 is updated for that specific call. The window 875 provides a chronological list of each significant event for Bert that the agent activity monitor 215 has identified. With each event, the section 875 provides the event time 880 along with a brief description of each event 885.

The information that the window 800 presents can be updated on a real-time, near real-time, or event basis. In one exemplary embodiment, the information is refreshed or updated at least once during each contact episode. The information can be updated on a time basis, such as every second, minute, two minutes, three minutes, ten minutes, etc. or in a range thereof.

Processes of an exemplary embodiment of the present invention will now be described with reference to FIGS. 9-15. The present invention can include multiple computer programs which embody the functions described herein and illustrated in the exemplary flowcharts of FIGS. 9-13 and 15, the functional block diagrams of FIGS. 14, the reports of FIG. 14, and the GUI displays of FIGS. 5-8. However, it should be apparent that there could be many different ways of implementing the invention in computer programming, and the invention should not be construed as limited to any one set of computer program instructions. Further, a skilled programmer would be able to write such a computer program to implement the disclosed invention without difficulty based on the exemplary data tables and flowcharts and associated description in the application text, for example.

Therefore, disclosure of a particular set of program code instructions is not considered necessary for an adequate understanding of how to make and use the invention. The inventive functionality of any claimed process or computer program will be explained in more detail in the following description in conjunction with the remaining figures illustrating the functions and program flow.

Certain steps in the processes described below must naturally precede others for the present invention to function as described. However, the present invention is not limited to the order of the steps described if such order or sequence does not alter the functionality of the present invention. That is, it is recognized that some steps may be performed before or after other steps or in parallel with other steps without departing from the scope and spirit of the present invention.

Turning now to FIGS. 9A and 9B, these figures illustrate a flowchart of an exemplary process 900, entitled Identify Significant Events, for identifying significant events occurring while an agent 160 services a contact 105 in accordance with an embodiment of the present invention.

At Step 905, the first step in Process 900, the agent 160 accesses the software application 450 in connection with providing service to a contact 105. As discussed above, the software application 450 provides a GUI on the display monitor 441 through which the agent 160 enters and receives information.

In one exemplary embodiment, the agent 160 may access a plurality of software applications 450, 451, 455 during an episode of servicing a contact 105. In this situation, Process 900 and the other routines that it calls identify and process events associated with each of these software applications 450, 451, 455. The number of software applications 450, 451, 455 that can be handled concurrently can be essentially unlimited or can be a function of the amount of computing resources that are available for this task.

At Step 910, the agent 160 enters an input, which may comprise data, a message, or an instruction, into the software application 450. A keyboard 435, mouse 430, or microphone can convert mechanical energy that the agent 160 generates into one or more electrical signals that the agent PC 405 can recognize and process.

At Step 915, the software application 450 receives the agent's entry in its electrical form. The operating system 420 conveys the entry as digital data to the software application 450.

At Step 920, the software application 450 responds to the agent's entry into the GUI and outputs a graphical or textual response for presentation on the display monitor 441. The GUI module 440 receives and processes the software application's output at Step 925. The GUI module's processing places that output in a standard format that the display monitor 441 can recognize or interpret.

At Step 930, the GUI module 440 sends the output to the display monitor 441 as one or more instructions or signals. The display monitor 441 receives those output signals at Step 935 and in response generates graphics or text. The display monitor 441 shows the graphics or text for the agent 160 to view.

At Step 940, the GUI monitoring module 460 detects, senses, or acquires the GUI module's activities. The GUI monitoring module 460 can access a register that the GUI module 440 uses for holding output to the display monitor 441, for example.

At Step 945, the GUI monitoring module 460 provides the agent activity monitor 215 with the information that it obtained from the GUI module 440. At Step 950, the agent activity monitor 215 receives and processes that information. The agent activity monitor 215 applies event criteria or rules to the detected activities to determine whether any event has relevance to assessing the agent's contact-processing behavior. As discussed above, a routine cursor movement is an example of an activity that is generally superfluous or extraneous to assessing or evaluating an agent 160. In contrast, an event such as clicking on a “sold item” button is typically significant.

In an exemplary embodiment, the rules or criteria that the agent activity monitor 215 applies are coded therein. Alternatively, the supervisor 175 or another member of the contact center's management can configure the agent activity monitor 215 to increase or decrease its filtering of display information.

At inquiry Step 955, the agent activity monitor 215 determines if a detected event is significant based on the criteria or rules that it applies. If the detected event is insignificant or inconsequential, Process 900 loops back to Step 910 and continues processing events. If the detected event is determined to be significant, then Step 960, illustrated on FIG. 9B, follows Step 955.

At Step 960, the agent activity monitor 215 transmits the significant event, which it has identified, to the agent activity server 325 for processing by the activity processing module 220. The activity processing module 220 receives the significant event at Step 965.

At Step 970, the activity processing module 220 stores the significant event in the database 360. Thus, the database 360 maintains a record for each agent 160 of the contact center 100 of significant activities or interactions with the GUI of the software application 450.

At Step 975, the activity processing module 220 processes the significant events and can initiate training or another action as appropriate. FIG. 10 illustrates a flowchart of Step 975 as a sub-process or subroutine of Process 900. Following execution of Step 975, at Step 980, Process 900 returns to Step 910 and continues therefrom.

Turning now to FIG. 10, this figure illustrates a flowchart of an exemplary process 975, entitled Process Significant Events, for processing significant events occurring while an agent 160 services a contact 105 in accordance with an embodiment of the present invention. As discussed above with reference to FIGS. 9A and 9B, Process 900 can execute Process 975 as a subroutine.

At Step 1010, the activity processing module 220 categorizes the incoming significant events. An individual event or a plurality of events, such as an event series or pattern of events, can receive categorization. Exemplary event categories can be informational, training assignment, error alert, and noncompliance as illustrated on in the window 610 of FIG. 6 and discussed above. Management of the contact center 100 may elect to configure the agent management system 190 to provide a greater or a lesser number of event categories according to preference.

The informational category can contain events of informational value to managing the contact center 100 but that have not been directly correlated to agent performance. An event in which an agent 160 entered or exited a training break could be categorized or classified as informational. Another example of an event that could be considered informational is an agent 160 failing to use a newly issued script while attempting to sell an upgraded product to a contact 105. Yet another example of an informational event could be an agent 160 achieving a significant sales result, such as multiple upgraded sales within a designated period of time.

The training assignment category holds instances of the WPES 120 assigning training to an agent 160.

The activity processing module 220 can place into the error alert category events that may be a cause for concern but that are not in direct noncompliance with the contact center's defined procedures or protocols. An example of such an event is an agent 160 placing a customer on hold an excessive number of times within a designated span of time. Another example could be an agent 160 repetitively taking too long to enter data into a form.

Events that do not comply with the contact center's defined contact-processing protocols, procedures, or guidelines can be considered noncompliant. Events that indicate a significant problem or cause for concern can also receive the noncompliant designation. For example, an agent 160 that received numerous error messages from the software 450 may be noncompliant.

In one exemplary embodiment, the noncompliant designation (or a another distinct designation) can indicate events that deviate from a procedure, rule, code, or law that a government entity or organization other than the contact center has set forth. For example, the activity processing module 220 can determine whether an agent 160 discussing or handling a SEC-regulated security has disclosed information to a contact 105 as may be required by a government-mandated security regulation.

Another category can highlight differences between top-performing agents 160 and other agents 160. The activity processing module 220 can identify instances in which an average-performing agent 160 consistently handles contacts 105 using different steps or methods than the top performers, for example. In this manner, the activity processing module 220 can compare each agent 160 to the center's best known agents 160 and can identify whether an agent 160 is on a path that is likely to lead to success.

Following event categorization at Step 1010, Process 975 proceeds with four exemplary subroutines or sub-processes that initiate actions as warranted based on event processing and business rules. At Step 1020, the supervisor 175 receives notification, typically in real-time, in response to an occurrence of a certain event.

At Step 1030, an agent 160 or other member of the contact center workforce can receive training as circumstances dictate. Step 1030 can be viewed as a process, method, or routine for automatically assigning coaching content to an agent 160. At Step 1040, the supervisor 175 receives reports of categorized agent events.

At Step 1050, the activity processing module 220 provides managerial insight by correlating events or event patterns with the results that each agent 160 achieves. Knowing the actions that drive results, the WPES 120 can train the contact center's workforce on those actions to positively impact business objectives. Following Step 1050, Process 975 ends.

FIGS. 11, 12, 13, and 15 respectively illustrate flowcharts for the Steps 1020, 1030, 1040, and 1050 as will be discussed below.

Turning now to FIG. 11, this figure illustrates a flowchart of an exemplary process 1020 for notifying an agent's supervisor 175 in response to occurrences of certain events in accordance with an embodiment of the present invention. Process 1020, which is entitled Notify Supervisor, can be Step 1020 of Process 975 as discussed above with reference to FIG. 10.

At Step 1110, the first step in Process 1020, the activity processing module 220 applies criteria or rules to the events that were categorized in Step 1010 of Process 975. The supervisor 175 has flexibility to set those criteria according to his or her management style or preference. Thus, a supervisor 175 can set one or more thresholds that trigger the agent oversight module 225 to send notifications upon occurrences of certain events.

At decision Step 1120, Process 1020 branches according to whether an event meets a notification criterion. If the event does not meet any of the criteria, then inquiry Step 1130 follows Step 1120. If the event meets at least one notification criterion, then Step 1150 follows Step 1120.

At Step 1130, the activity processing module 220 determines whether the event in combination with one or more other, typically earlier, events meets a notification criterion. A supervisor 175 can receive notification upon occurrence of a pattern or series of events, such as an agent 160 performing a step or achieving a goal a set number of times within a predefined time interval. If the event in combination with earlier events does not comprise a notifiable set of events, Process 1020 ends. If a set of events comprising the current event meets one or more notification criteria, then Step 1150 follows Step 1130. Step 1130 also follows Step 1120 if the event meets a single-event criterion as discussed above.

At Step 1150, the activity processing module 220 notifies the agent oversight module 225 of the event or set of events that warrant supervisor notification. The agent oversight module 225 responds at Step 1160 and sends notification to the supervisor 175 for display on the supervisor station 180 and on the handheld 340.

At Step 1170, the agent oversight module 225 sends a copy of the notification to the agent 160. Thus, the agent 160 remains informed about the information that the supervisor 175 has received regarding his or her contact-processing methods. Process 1020 ends following Step 1170.

In one exemplary embodiment, Process 1020 initiates recording the interaction or service episode between the agent 160 and the contact 105 if circumstances warrant. For example, a step (not shown) between Step 1150 and 1160 can comprise recording the agent's computer entries, the GUI interactions, and/or the dialogue between the agent 160 and the contact 105. In one exemplary embodiment, a set of rules that are distinct from the supervisor-notification rules of Step 1120 and Step 1130 determine whether the service episode is recorded. The recording can be compressed to reduce media storage requirements for subsequent review by an automated system or a human manager.

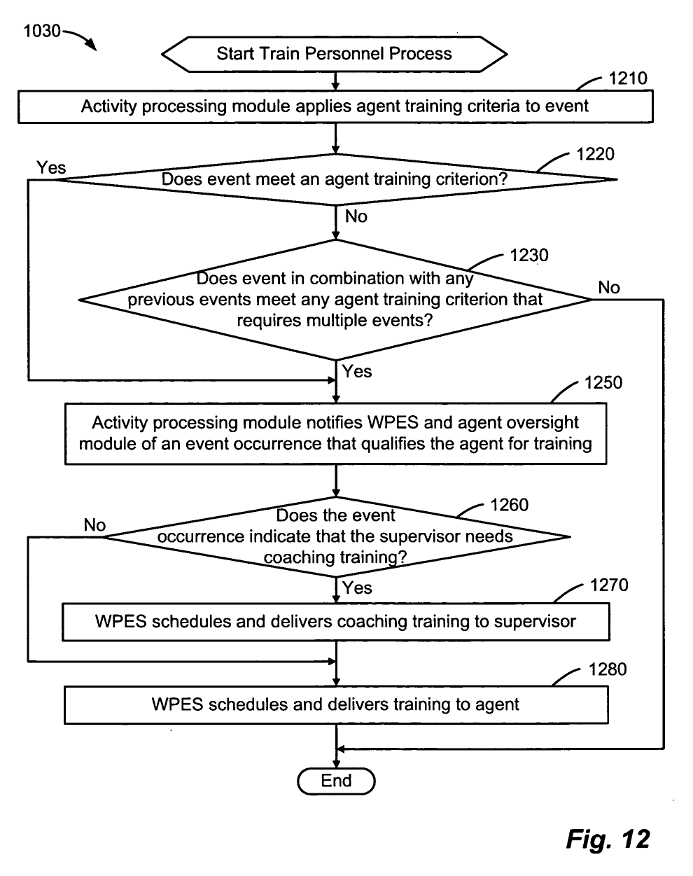

Turning now to FIG. 12, this figure illustrates a flowchart of an exemplary process 1030 for initiating training in response to occurrences of certain events in accordance with an embodiment of the present invention. Process 1030, which is entitled Train Personnel, can be Step 1030 of Process 975 as discussed above with reference to FIG. 10.

At Step 1210, the first step in Process 1030, the activity processing module 220 applies agent training criteria or rules to the event. As discussed above, the criteria application determines whether the agent 160 should receive training based on the occurrence of the event. Such training can comprise coaching, a warning, information, a tip, remedial training, etc.

Decision Step 1220 branches Process 1030 to Step 1250 if the event meets a training criterion or to Step 1230 if the event does not meet one or more training criteria. At inquiry Step 1230, the activity processing module 220 determines whether the event and any previous events complete a set or series of events that indicate that the agent's performance would benefit from training.

If at Step 1230 the activity processing module 220 does not identify a set of events that meet a criterion to initiate training, Process 1030 ends. If the activity processing module 220 determines that the occurrence of the event completes a single-event criterion at Step 1220 or a multi-event criterion at Step 1230, then Process 1030 executes Step 1250.

At Step 1250, the activity processing module 220 notifies the WPES 120 and the agent oversight module 225 that the agent 160 is to receive training in response to the manner in which the agent 160 handled one or more contact service encounters. The agent oversight module 225 sends the notification to the supervisor 175 via a display at the supervisor station 180 and to the supervisor's handheld 340. The agent 160 also receives notification that training or another performance intervention will be delivered immediately or at a future time.

At decision Step 1260, the activity processing module 220 applies additional criteria to the event to determine whether the supervisor 175 should receive training. A situation that could qualify the supervisor 175 for training could comprise an error or procedural deviation that multiple agents 160 have committed in a designated interval of time such as an hour, day, week, month, or in a range thereof.

If supervisor training is warranted, the WPES 120 selects appropriate training, schedules a training session with the supervisor 175, and delivers the training to the supervisor 175 at Step 1270. The training can help the supervisor 175 become a better manager of people, inform the supervisor 175 about a recommended procedure that the agent 160 should adopt, enhance the supervisor's coaching skills, or prepare the supervisor 175 for a one-on-one meeting with the agent 160, for example.

In one exemplary embodiment, the supervisor 175 receives a bundle of information and materials relevant to managing the agent 160. For example, the supervisor 175 can receive a report of the agent's performance history, one or more coaching tips, or prescriptive advice. Step 1280 follows Step 1270.

If the event occurrence does not qualify the supervisor 175 for training in accordance with the criteria of Step 1260, then the WPES 120 schedules and delivers training to the agent 160 at Step 1280. The agent 160 may receive the training immediately after completing the contact episode that triggered the training assignment. Sending training to the agent 160 after the agent 160 finishes servicing the current contact 105 and before the agent 160 begins servicing another contact 105 can be effective, as prompt coaching typically yields strong behavioral change.

However, service levels pressures of the contact center 100 can be a factor in selecting a time to deliver training to an agent 160. The WPES 120 can delay delivering coaching to an agent 160 until call volume has dropped below a threshold, for example. In this manner, the agent 160 can receive the content without disrupting the center's operations or compromising a service level goal, such as answering 80 percent of incoming calls within twenty seconds.

When coaching or training content is concise and focused, content can often be delivered immediately following undesirable behavior without negatively impacting service level. In this manner, training can have a positive behavioral impact without unnecessarily consuming the agent's time. That is, timely training can improve the agent's performance while the event is fresh in the agent's mind. Such training can be effective as a tip or a short burst of information, such as a single sentence, two-to-three sentences, or a paragraph. Delivering training content in this rapid manner can offer time efficiencies in comparison to scheduling a lengthy training session for a later hour or a following day. Efficient use of the agent's time for training helps the contact center 100 meet its business or profit objectives as training time typically has a cost associated with employee pay.

As an alternative to delivering training immediately, the WPES 120, the activity processing module 220, the agent 160, or the supervisor 175 can elect to schedule training in the near future. The scheduled time can be a time period that is forecast to enhance the training's impact. Training can be scheduled for a time when the contact center's workforce will have a heightened motivation to learn or listen. For example, training may coincide with the contact center 100 receiving the results of a campaign to meet a business objective and workforce motivation is in a heightened state. Agents 160 may also be alert and receptive to training at the beginning of a shift, when they are fresh and fully rested.

Process 1030 ends following execution of Step 1280 or a negative determination at Step 1230 as discussed above.

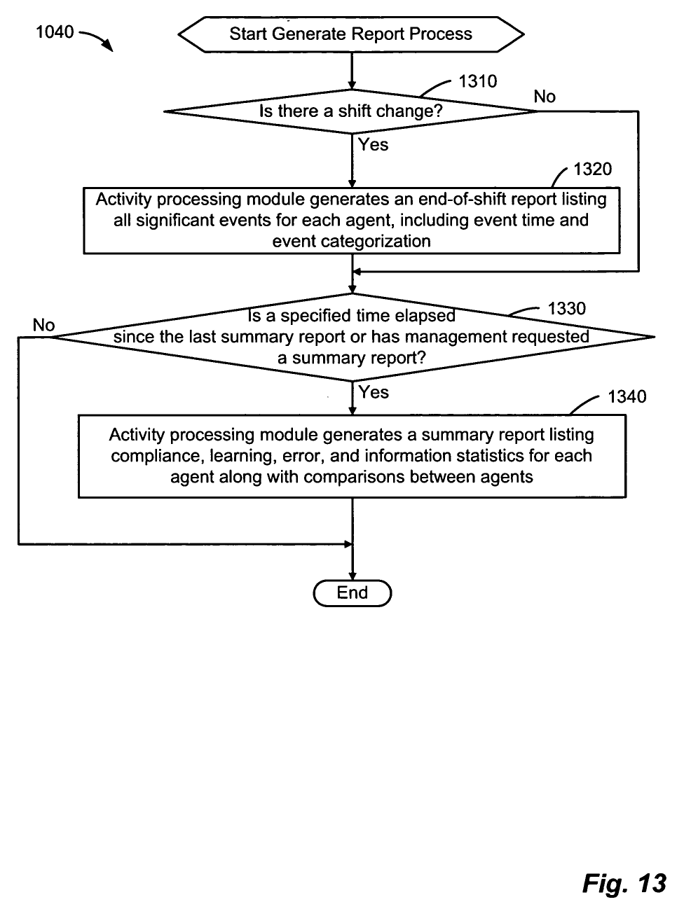

Turning now to FIG. 13, this figure illustrates a flowchart of an exemplary process 1040 for generating a report of certain events in accordance with an embodiment of the present invention. The report can comprise a categorized list of each event that the agent activity monitor 215 has identified or flagged during a time period such as an hour, shift, week, month, etc.

The report that Process 1040 generates can comprise one or more of the display windows 610, 700, 800, or the information contained therein, that FIGS. 6, 7, and 8 respectively illustrate as discussed above. FIGS. 14A, B, and C, which are discussed below, illustrate three exemplary reports 1425, 1450, 1475 that are formatted as charts. Process 1040, which is entitled Generate Report, can be Step 1040 of Process 975 as discussed above with reference to FIG. 10.

At inquiry Step 1310, the first step in Process 1040, the activity processing module 220 determines whether a shift change has occurred since the last time that Process 1040 checked for a shift change. As an alternative to a shift change, the activity processing module 220 can apply another criterion that may comprise a time-based rule or another parameter. If a shift change has occurred or is occurring, then Step 1320 follows Step 1310, otherwise decision Step 1330 follows Step 1310.

At Step 1320, the activity processing module 220 generates an end-of-shift report. The end-of-shift report provides a list of each significant event, the category of each listed event, the agents 160 or agent 160, involved, and a timestamp. The supervisor 175 can elect to customize the report to include additional information or delete information considered nonessential or superfluous. The activity processing module 220 forwards the generated report to the supervisor station 180 for presentation to the supervisor 175 or generates a hard copy printout.

At Step 1330, the activity processing module 220 determines whether a selected or specified amount of time has elapsed since the last generation of a summary report. If a schedule indicates that a summary report should be compiled or if the supervisor 175 or another manager requests such a report, Step 1340 follows Step 1330. If a summary report is not due or requested, Process 1040 ends following Step 1330.

At Step 1340, the activity processing module 220 processes or analyzes the events stored in the database 360 to generate one or more comprehensive reports of agent activities in the contact center 100 during the subject timeframe. A report can provide comparative data between agents 160, statistics, training summaries, or trends over time of errors or compliance breaches, shift-to-shift comparisons, or training summaries, for example. As discussed below, FIGS. 14A, 14B, and 14C show exemplary reports 1425, 1450, 1475 that can result from executing Process 1040.

The supervisor 175 typically receives the report at the supervisor station 180 while other members of the contact center's management receive the report at their respective computers via the network 165. Process 1040 ends following Step 1340.

Turning now to FIGS. 14A, B, and C, these figures illustrate exemplary reports 1425, 1450, 1475 for charting event occurrences in accordance with an embodiment of the present invention. These charts or reports 1425, 1450, 1475 present simulated data.

The report 1425 of FIG. 14A compares the call handling of a specific agent, Marge 1430, to that of an average agent 1435 and a best-practice or top performing agent 1440. The chart 1425 shows the time that Marge 1430 uses for each step in changing an address and compares Marge's times to those of the center's best performing agents 1440 and average agents 1435. The chart 1425 also presents the close ratios for Marge 1430, the best performers 1440, and the average performers 1435.

A contact 105 may call the contact center 100 to inform an insurance company that he or she has moved to a new address, for example. According to the contact center's approved procedure, the agent 160 queries the contact 105, records the change-of-address data, and attempts to sell the contact 105 a product or service.

Marge 1430 takes approximately 19 minutes to service the caller 105, during which she performs the steps of retrieving the caller's account, modifying the recorded address, up-selling or attempting to sell the caller 105 a product or service in addition to servicing the caller's address-change needs, and exiting the call. In comparison to Marge 1430, the average agent 1435 needs approximately 14 minutes to perform these steps. The best-practice procedure 1440 of the best performers takes approximately 13 minutes. In addition to illustrating the total times, the chart 1425 breaks down the respective times that Marge 1430, the average agent 1435, and the best-practice agent 1440 each takes to perform the individual steps associated with completing the address change. Thus, the chart 1425 can provide a time or performance breakdown on a task-by-task basis.

If desired, the supervisor 175 can select a specific bar on the chart 1425 to access a more detailed or real-time analysis. For example, the supervisor 175 can obtain supplemental information about Marge's actions during the time she performed up-selling activities. The up-sell can be a contact episode in which the contact 105 buys a good or service that he or she did not intend to purchase or contemplate purchasing at the onset of the call.

The report 1450 of FIG. 14B charts the attempts and close ratios for all of the agents 160 in the contact center 100. The data of the chart 1450 is distributed in the general form of a bell-shaped curve. That is, that data is statistical and could be fitted to a bell-shaped curve. On one end of the chart 1450, five agents 160 closed (for example in an attempt to up-sell) with a frequency of 5.7 percent. On the other extreme, eight agents 160 closed with a frequency of 19.3 percent. The chart 1450 further presents the attempt ratio, thus showing the frequency with which the agents 160 attempted (either successfully or unsuccessfully) to make the up-sell.

In one exemplary embodiment, the supervisor 175 can access detailed or “drill-down” information by clicking on one of the data bars of the chart 1450. In response, the activity processing module 220 can initiate or conduct a data analysis, for example uncovering or discovering causal or noncausal relationships. The insight of such relationships can help operate the contact center 100 more effectively. In one embodiment, the activity processing module engages an online analytical processing (“OLAP”) engine. The OLAP engine can process information in a real-time, near-real-time, or post-real-time manner. The database 360 can store agent data in a format that facilitates real-time or prompt online analysis.

The report 1475 of FIG. 14C charts up-selling statistics for three types of services, namely processing a billing inquiry, providing change-of-address service, and opening an account.

The pie chart 1480 describes 111 billing inquiry calls. For 18 calls, the caller is not qualified to receive a pitch for an up-sell; thus, the agent 160 does not attempt to up-sell the caller. For 42 billing inquiry calls, the chart 1480 shows that the agent 160 does not attempt an up-sell for a reason other than the caller's lack of qualification. For 39 calls, the agent 160 completes a successful up-sell, while the attempted up-sell is unsuccessful for 12 calls.

The pie chart 1485 presents up-selling data for 196 change-of-address calls. For 46 calls, the agent 160 does not attempt an up-sell because the caller is not qualified or does not meet a criterion to receive a sales pitch. For 77 calls, the agent 160 does not attempt the up-sell for a reason other than the caller's lack of qualification. For 37 calls, the agent 160 successful closes an up-sell, while the attempted up-sell is unsuccessful for 36 calls.

The pie chart 1490 presents up-selling statistics for 136 calls in which the caller seeks to open an account. For 33 calls, the caller is not eligible to receive a sales pitch. The agent 160 does not attempt the up-sell for a reason other than the caller's lack of qualification for 59 calls. The agent 160 unsuccessfully attempts an up-sell for 8 calls and successfully closes 36 up-selling opportunities.

The charts 1480, 1485, 1490 can provide data for a specific agent 160, for a group or shift of agents 160, or for the entire agent workforce 160.

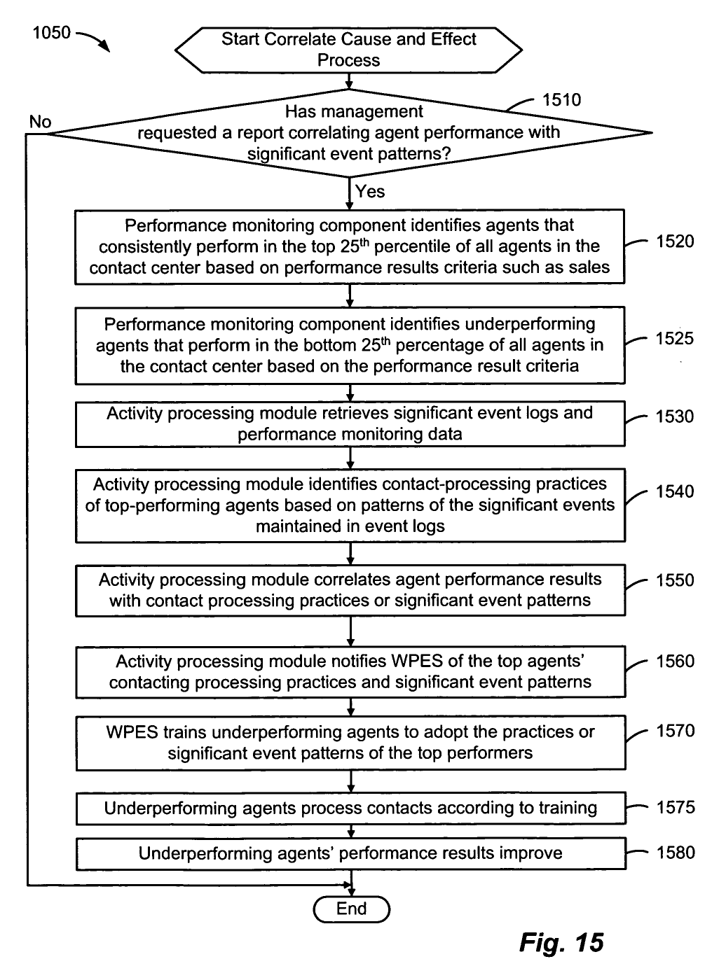

Turning now to FIG. 15, this figure illustrates a flowchart of an exemplary process 1050 for correlating results to occurrences of certain events in accordance with an embodiment of the present invention. Process 1050, which is entitled Correlate Cause and Effect, can be Step 1050 of Process 975 as discussed above with reference to FIG. 10.

The activity processing module 220 can identify behavior patterns for each agent 160 of the contact center 100 based on monitored events stored in the database 360. That is, the agent management system 190 can ascertain the methodologies, techniques, or peculiarities that each agent 160 uses to process a contact 105. Experienced or successful agents 160 often perform a distinctive pattern of steps to successfully process a contact 160. Meanwhile, unsuccessful agents 160 often commit common mistakes or a common series of errors or otherwise fail to use winning methods.

The chart 1425 of FIG. 14A, discussed above, illustrates an example of analyzing the contact processing metrics for processing a contact 105. In this case, the processing time that an agent 160 needs for each step in handling a contact 105 is compared to other agents 160 or other statistics for the contact center 100.

The activity processing module 220 can pattern the behaviors of each agent 160 across a continuum of demonstrated performance results. For example, the activity processing module 220 can acquire performance data for each agent 160 from the performance monitoring component 145. That performance data can be fitted to a statistical distribution, such as a bell curve, so that each agent's performance occupies or is fitted to a position on the bell curve. For example, the chart 1450 of FIG. 14B, discussed above, illustrates plotting agent data as a statistical distribution.

The activity processing module 220 can correlate the distinctive contact-processing techniques of each agent 160 to the agent's position on the performance bell curve. The activity processing module 220 can then identify contact-processing patterns that are common to the top performing agents 160. For example, the activity processing module 220 can identify a sequence of steps regularly performed by the agents 160 who consistently achieve performance two standard deviations above (or below) the mean or statistically related to another threshold.

The activity processing module 220 can send to the WPES 120 the information that it has identified regarding successful contact-processing techniques. The WPES 120 can present or teach those winning techniques to the agents 160 who are not already practicing them. The WPES 120 can elect to concentrate its training on the agents 160 that demonstrate average results. Alternatively, the WPES 120 can also train the agents 160 that consistently perform in the bottom twenty five percent of the agent population 160 or below another threshold. The content for each performance category of agents 160 can be tailored for moving that category, for example for converting low performers to average performers or for converting average performers to top performers.

The correlation of cause and effect can comprise statistical methods, data mining, and processes that learn in an iterative manner. Such processes can be referred to as artificially intelligent (“AI”) and can comprise one or more steps executed by fuzzy logic, a neural network, or an inference engine, as will be appreciated by those skilled in the AI arts. A neural network can be a module that simulates intelligence by attempting to reproduce the types of physical connections that occur in animal brains. An inference engine can be an induction engine, a deduction engine, or an abduction engine. Thus, a relationship between cause and effect can be identified and can be induced via inductive reasoning, deduced via deductive reasoning, or abducted via abductive reasoning.

In one exemplary embodiment, the activity processing module 220 identifies an outcome that resulted from one or more agent's behavior. In another exemplary embodiment, the activity processing module 220 identifies agent behavior that caused a outcome, such as a change in a value of a key performance indicator (KPI). Thus, a causal relationship can be established by analyzing outcomes/outputs, inputs (agent behavior), or both outcomes and inputs.

Process 1050 provides exemplary steps for correlating agent behavior to achieved results to support enhancing the performance of the contact center's workforce. At decision Step 1510, the first step in Process 1050, the activity processing module 220 determines whether a supervisor 175 or another manager has requested a report correlating agent performance to patterns of significant events that the agent management system 190 has detected.

If the activity processing module 220 has not received a request for such a report, Process 1050 ends. On the other hand, Step 1520 follows a manager's request for a correlation between cause and effect.

At Step 1520, the performance monitoring component 145 identifies the agents 160 who perform in the top twenty-fifth percentile of the contact center's agent workforce 160. Performance can be a function of one or more of sales volume, sales of a particular item, problem resolution, call processing time, complaints, or any of the various performance metrics known to those skilled in the art.

At Step 1525, the performance monitoring component 145 identifies the agents 160 performing in the bottom twenty-fifth percentile. The performance monitoring component 145 typically uses the same performance metrics at Step 1525 as at Step 1520.

Those skilled in the art will appreciate that Process 1050 can work with a wide range of metrics, statistical divisions, indices, segmentations, and classification methodologies. For example, Process 1050 can use quintiles to segment the agent population 160 into fifths.

At Step 1530, the activity processing module 220 receives the performance data resulting from Steps 1520 and 1525 and obtains logs of significant agent events from the database 360. The timeframe of the event logs typically coincides with the timeframe of the performance data.

At Step 1540, the activity processing module 220 identifies the contact-processing practices of the agents 160 whose performance ranked in the top twenty five percent. At Step 1550, the activity processing module 220 processes the stored events of these top-performing agents 160 to identify one or more common patterns in their contact-processing methods.

At Step 1560, the activity processing module 220 notifies the WPES 120 of the patterns that it has identified. That is, the activity processing module 220 informs the WPES 120 of contact-processing patterns that have produced above average results with statistically significant regularity. In this manner the activity processing module 220 can discover techniques that the contact center 100 can adopt as best practices.

At Step 1570, the WPES 120 trains the agents 160 who ranked in the bottom seventy five percent of the agent population 160. The WPES 120 teaches the bottom-performing agents 160 to practice the successful techniques that the top-performing agents 160 use. That is, the WPES 120 uses the contact center's top performers as model agents 160 and teaches the rest of the agent population 160 the model agents' techniques.

At Step 1580, the performance of the underperforming agents 160 improves. Agents 160 typically retain what they learn and thereby sustain the improvement. More specifically, delivering training content in small or manageable increments via recurring or repetitive delivery can help the agents 160 adopt and remember desirable behavior to yield sustainable results. In this manner, the agent management system 190 and the WPES 120 can improve the performance of the contact center's workforce thereby helping the contact center 100 achieve its business objectives.

Performance improvement of one or more agents 160 or of the contact center 100 as a whole at Step 1580 can confirm or validate a best practice. In one exemplary embodiment of Process 1050, the practices identified at Step 1540 are considered candidates for best practices or hypothesized best practices until validated at Step 1580. In this manner, the agent management system 190 can adapt to changing conditions in the contact center's operating environment and can learn in an iterative manner.

Process 1050 ends following Step 1580.

In summary, the present invention supports improving workforce performance in a contact center by identifying instances or patterns of agent behavior likely to have a positive or negative impact on the contact center's performance. Negative behavior can be addressed with prompt or timely corrective training delivered to targeted members of the workforce. Training can also encourage or propagate positive behavior patterns that have been identified.

From the foregoing, it will be appreciated that the preferred embodiment of the present invention overcomes the limitations of the prior art. From the description of the preferred embodiment, equivalents of the elements shown therein will suggest themselves to those skilled in the art, and ways of constructing other embodiments of the present invention will suggest themselves to practitioners of the art. Therefore, the scope of the present invention is to be limited only by the claims below.

What is claimed is:

1. A method of delivering content to an agent of a contact center in response to monitoring agent events, comprising the steps of:
receiving a notification of an occurrence of one of the agent events;
processing the notification to identify an action that the agent has taken in connection with use of a software program at the contact center to service a contact;
determining if the action is indicative of a need for training of the agent; and
initiating a training session for presentation of the content to the agent if the action is determined to be indicative of the need for training.

2. The method of claim 1, wherein the one of the agent events comprises an interaction between the agent and a user interface associated with the software program.

3. The method of claim 1, wherein the one of the agent events comprises audible communication.

4. The method of claim 1, wherein the determining step comprises determining if the action complies with a guideline for servicing the contact.

5. The method of claim 1, wherein:
the receiving step further comprises receiving a second notification of a second occurrence of the one of the agent events;
the processing step further comprises processing the second notification to identify a second action that the agent has taken in connection with use of the software program; and
the determining step comprises determining if the action and the second action are indicative of the need for training of the agent based on whether the action and the second action occurred during a timeframe.

6. The method of claim 1, further comprising the step of determining whether the agent has completed servicing the contact, wherein the initiating step further comprises initiating the training session in response to a determination that the agent has completed servicing the contact.

7. The method of claim 1, further comprising the step of identifying a time period that the training session is predicted to have a heightened influence on the agent, wherein the initiating step comprises initiating the training session during the identified time period.

8. The method of claim 1, further comprising the steps of:
determining if the action is indicative of a need for training of a supervisor of the agent; and
initiating a second training session for the supervisor if the action is indicative of the need for training of the supervisor.

9. The method of claim 1, further comprising the step of sending a message to a supervisor of the agent notifying the supervisor of the action that the agent has taken.

10. The method of claim 9, further comprising the step of sending a copy of the message to the agent.

11. The method of claim 1, further comprising the step of presenting the content to the agent after the agent has serviced the contact and before the agent services another contact.

12. The method of claim 1, wherein initiating the training session comprises initiating the training session before the agent begins servicing another contact.

13. A method for providing training content to an agent of a contact center, comprising:
receiving a communication describing an entry made by the agent into a software program that supports processing a contact;
associating the entry with a step taken by the agent in connection with processing the contact;
determining if the step taken by the agent indicates a training need; and
if the step taken by the agent is determined to indicate the training need, assigning the training content to the agent.

14. The method of claim 13, wherein the entry comprises a word spoken by the agent.

15. The method of claim 13, wherein determining if the step taken by the agent indicates a training need comprises determining if the agent has taken the step at least two times during an interval of time.

16. The method of claim 13, wherein determining if the step taken by the agent indicates a training need comprises determining if the agent has repeated the step.

17. The method of claim 13, wherein sending the training content to the agent comprises initiating a training session after the agent has processed the contact and before the agent has processed another contact.

18. The method of claim 13, wherein the sending step comprises sending the training content to the agent before the agent begins processing another contact.

19. The method of claim 13, further comprising the steps of:
determining whether the step taken by the agent indicates that a workforce member of the contact center other than the agent needs training; and
training the member if the step taken by the agent indicates that the member needs training.

20. The method of claim 19, wherein the member is a supervisor of the agent.

21. A computer-implemented method for enhancing workforce performance of a contact center, comprising the steps of:
receiving data about an action that an agent of the contact center has taken in connection with servicing a contact;
processing the received data to determine if the action meets a criterion; and
if the action is determined to meet the criterion, initiating a training session after the agent has serviced the contact and before the agent services another contact.

22. The computer-implemented method of claim 21, further comprising the step of completing the initiated training session before the agent services the another contact.

23. The computer-implemented method of claim 21, wherein initiating the training session comprises sending training content to the agent after the agent has completed servicing the contact and before the agent begins servicing the another contact.

24. The computer-implemented method of claim 23, further comprising the step of initiating a second training session with a manager of the agent if the action meets a second criterion.

25. The computer-implemented method of claim 21, further comprising the step of sending training content to an employee of the contact center other than the agent if the action is determined to meet the criterion.

26. A method of delivering content to a supervisor of an agent in a contact center in response to monitoring agent events, comprising the steps of:
receiving a notification of an occurrence of one of the agent events;
processing the notification to identify an action that the agent has taken in connection with servicing a contact;
determining if the action is indicative of a need for training of the supervisor; and
initiating a training session for presentation of the content to the supervisor if the action is determined to be indicative of the need for training.

27. The method of claim 26, further comprising the steps of:
determining if the action indicates that the agent would benefit from training; and
if the action indicates that the agent would benefit from training, training the agent after the agent services the contact and before the agent services a second contact.

28. The method of claim 26, wherein presentation of the content to the supervisor comprises preparing the supervisor for interacting with the agent.

29. A method for enhancing workforce performance in a contact center, comprising the steps of:
identifying a first agent of the contact center who exhibits higher performance than a second agent;
in response to monitoring interactions between the first agent and a software program, receiving notifications of occurrences of agent events;
processing the received notifications to identify a step that the first agent has taken in connection with servicing a contact; and
teaching the step to the second agent.

30. The method of claim 29, wherein identifying the step comprises identifying a pattern of steps that the first agent has taken in connection with servicing the contact.

31. The method of claim 29, wherein the processing step comprises processing the received notification to identify a methodology, comprising the step, that the first agent has taken in connection with servicing the contact.

32. The method of claim 31, wherein teaching the step to the second agent comprises teaching the methodology to the second agent.

33. The method of claim 32, wherein teaching the methodology to the second agent comprises sending content to the second agent over a network.

34. The method of claim 29, wherein the step of processing the received notification further comprises correlating the step to the higher performance exhibited by the first agent.

35. The method of claim 29, further comprising the step of monitoring performance of the first agent and the second agent.

36. A method for improving performance at a contact center, comprising the steps of:
monitoring agent performances in the contact center;
processing the monitored agent performances to identify first agents with performance above a threshold and second agents with performance below the threshold;
in response to monitoring communications between each of the first agents and a software program, receiving notifications of event occurrences for the first agents;
processing the notifications to identify a common action taken by each of the first agents in connection with processing a respective contact; and
sending content, operative to teach the common action, to the second agents.

37. The method of claim 36, wherein the receiving step comprises in response to monitoring the communications between each of the first agents and a respective copy of the software program, receiving the notifications of the event occurrences for the first agents.

38. The method of claim 36, wherein identifying the common action comprises identifying a pattern of steps taken by each of the first agents and wherein the content is further operative to train the second agents on the identified pattern of steps.

39. The method of claim 36, wherein processing the monitored performances comprises statistically analyzing the monitored performances.

40. The method of claim 36, wherein the software program is operative to display contact information in support of processing the respective contact.

41. The method of claim 36, wherein the receiving step comprises in response to monitoring communications between a respective copy of the software program and each of the first agents and the second agents, receiving notifications of event occurrences for the first agents and the second agents.

42. The method of claim 41, wherein processing the notifications to identify the common action comprises processing the notifications to identify a pattern of the event occurrences, distinguishable between the first agents and the second agents.

43. The method of claim 36, wherein the step of processing the notifications further comprises determining that each of the first agents took the common action a plurality of times.

44. A computer-implemented method for notifying a manager about an action that an agent of a contact center has taken in connection with servicing a contact, comprising the steps of:
receiving data about the action while the agent services the contact;
processing the received data to determine if the action meets a criterion; and
if the action is determined to meet the criterion, sending a notification of the action to the manager before the agent services another contact.

45. The computer-implemented method of claim 44, wherein sending the notification comprises sending the notification to the manager while the agent services the contact.

46. The computer-implemented method of claim 45, further comprising the step of sending a message, about the action, to the agent after the agent finishes servicing the contact and before the agent services the another contact.

47. The computer-implemented method of claim 44, further comprising the step of sending the notification to the agent.

48. The computer-implemented method of claim 44, wherein sending the notification comprises transmitting an e-mail over a wireless medium.

49. A method of delivering information to a supervisor of a contact center in response to monitoring agent events, comprising the steps of:
receiving a notification of an occurrence of one of the agent events;
processing the notification to identify an action that an agent has taken in connection with use of a software program at the contact center to service a contact;
determining if the action meets a criterion; and
sending a message about the action to the supervisor if the action is determined to meet the criterion.

50. The method of claim 49, wherein the receiving step and the sending step occur during an episode of the agent servicing the contact.

51. The method of claim 49, wherein the receiving step occurs before the agent finishes servicing the contact and the sending step occurs before the agent begins servicing another contact.

52. The method of claim 49, further comprising the step of informing the agent about the message after the agent completes a first service episode and before the agent starts a second service episode.

53. The method of claim 49, wherein the sending step comprises sending an e-mail to the supervisor.

54. The method of claim 49, wherein the sending step comprises transmitting the message to a handheld device via wireless transmission.

55. The method of claim 49 wherein the message comprises a notification that the agent has deviated from a defined procedure.

56. A computer-implemented method for observing activities in a contact center, comprising the steps of:
receiving communications about entries that an agent of the contact center has made into a user interface of a computer system;
processing the received communications to identify steps that the agent has taken in connection with handling a plurality of contacts; and
processing the identified steps to identify a procedure that the agent has used to handle at least two contacts in the plurality of contacts.

57. The computer-implemented method of claim 56, further comprising the steps of:
identifying a result that the agent has achieved; and
correlating the result to the identified procedure.

58. The computer-implemented method of claim 57, wherein the correlating step comprises determining that the result occurred in response to the identified procedure.

59. The method of claim 57, wherein the correlating step comprises statistically analyzing the identified steps.

60. The method of claim 57, wherein correlating the result to the identified procedure comprises conducting a statistical analysis.

61. The method of claim 56, further comprising the step of initiating a training session with a workforce member of the contact center other than the agent based on whether the identified procedure meets a criterion.

62. The method of claim 56, further comprising the step of instructing another agent of the contact center to use at least a portion of the identified procedure.

63. The method of claim 56, further comprising the steps of:
determining whether the identified procedure complies with another procedure; and
sending training content to the agent if the identified procedure does not comply with the another procedure.

64. The method of claim 56, wherein processing the identified steps to identify the procedure comprises identifying a pattern occurring in a plurality of contact sessions.
